(19) United States
(12) Patent Application Publication
(10) Pub. No.: US 2022/0397837 A1
(43) Pub. Date: Dec. 15, 2022

(54) TWO-COMPONENT DEVELOPER AND IMAGE FORMING METHOD

(71) Applicant: Konica Minolta, Inc., Tokyo (JP)

(72) Inventors: Takanari KAYAMORI, Kawasaki-shi (JP); Yuya KUBO, Tokyo (JP)

(21) Appl. No.: 17/825,149

(22) Filed: May 26, 2022

(30) Foreign Application Priority Data
Jun. 9, 2021 (JP) 2021-096640

(51) Int. Cl. G03G 9/09; G03G 9/097

(52) U.S. Cl. CPC G03G 9/0926; G03G 9/09708

(57) ABSTRACT

A two-component developer includes an electrostatic image developing toner and a carrier, and the electrostatic image developing toner contains toner particles having toner base particles and an external additive. The toner base particles contain a colorant, the colorant contains a pigment P1 and a pigment P2, the absorption maximum wavelength λmax of the pigments P1 and P2 each in dispersion in methyl ethyl ketone is, 400 nm or more and less than 600 nm for the pigment P1 and 600 nm or more and 700 nm or less for the pigment P2, the external additive contains titanium oxide, the content of the titanium oxide is 0.01% by mass or more and less than 1.00% by mass based on the total mass of the toner base particles, and the iron element content (atomic %) of the surface of the carrier as measured by X-ray electron spectroscopy satisfies a specific expression.

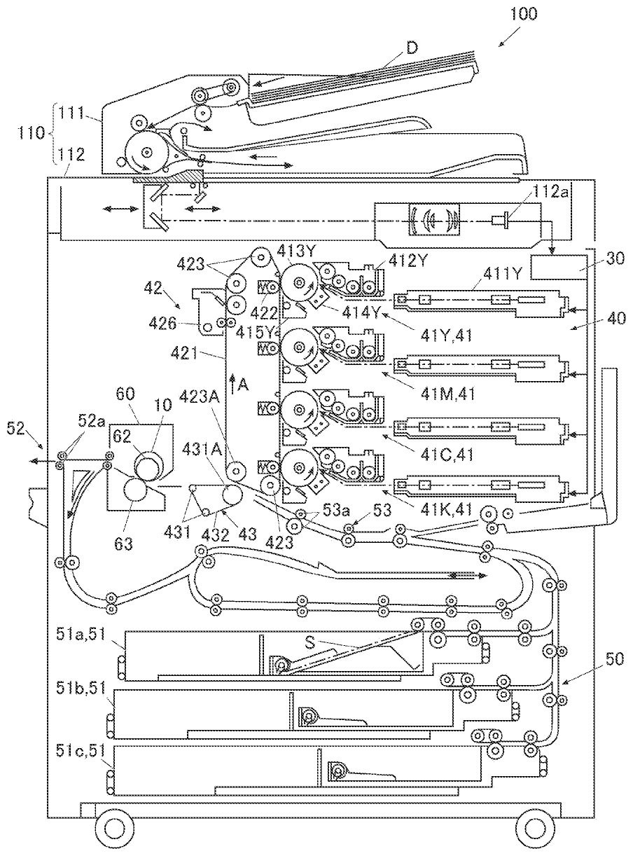

### CROSS-REFERENCE TO RELATED APPLICATIONS

The entire disclosure of Japanese Patent Application No. 2021-096640 filed on Jun. 9, 2021 is incorporated herein by reference in its entirety.

### BACKGROUND

### Technological Field

The present invention relates to a two-component developer and an image forming method. The present invention more specifically relates to a two-component developer having near-infrared light transmission, having a high image density, and having excellent resistance of chargeability to environmental conditions, and an image forming method.

### DESCRIPTION OF THE RELATED ART

Two-component developers composed of an electrostatic image developing toner (hereinafter, simply also referred to as a “toner”) and an electrostatic image developing carrier made of magnetic powder (hereinafter simply also referred to as a “carrier”) have been prevailing recently in electrophotographic copiers and printers.

In particular, with respect to toners, toners that include organic pigments of different tones internally added in one toner base particle (the toner base particle will be detailed below) and absorb light in a broad wavelength region are under development. In particular, toners that have properties of transmitting (being unlikely to absorb) light in the near-infrared light region in spite of absorbing light in the visible region are attracting attention. Using such a toner enables formation of an image that appears black but is detected as transparent by use of a detector having sensitivity only to near-infrared light. By taking advantage of these characteristics and by imparting near-infrared light transmission only to a portion of the image, formation of an image or the like including information imperceptible to the human eye embedded therein is expected.

For example, many of black toners that absorb visible light as disclosed in JP h5-297635A and JP 2009-79096A also absorb near-infrared light and thus do not have the properties as described above.

In a toner that includes pigments of different tones internally added in one toner base particle as described above, when titanium oxide is used as an external additive, titanium oxide having a high specific gravity is likely to migrate from the toner under high-temperature and high-humidity environment conditions, and the resistance of chargeability to environmental conditions is likely to be insufficient. For this reason, further improvement in the resistance of chargeability to environmental conditions has been required.

### SUMMARY

### Technical Problem

The present invention has been made in view of the foregoing problems and circumstances, and it is an object to be solved by the invention to provide a two-component developer having near-infrared light transmission, having a high image density, and having excellent resistance of chargeability to environmental conditions, and an image forming method.

### Solution to Problem

In an attempt to solve the above problems, the present inventor has investigated causes and the like of the foregoing problems and consequently has found that a two-component developer having near-infrared light transmission, having a high image density, and having excellent resistance of chargeability to environmental conditions, and an image forming method can be provided by, in a two-component developer that includes an electrostatic image developing toner containing toner particles having toner base particles and an external additive, and includes a carrier, allowing the toner base particles to contain a colorant that absorbs light in the visible light region, allowing titanium oxide to be contained as the external additive, and setting the iron element content on the carrier surface within a specific range, having reached the present invention.

That is, the foregoing object of the present invention will be achieved by the following measures.

A two-component developer includes an electrostatic image developing toner and a carrier, the electrostatic image developing toner containing toner particles having toner base particles and an external additive, wherein the toner base particles contain a colorant, the colorant contains a pigment P1 and a pigment P2, the absorption maximum wavelength λmax of the pigments P1 and P2 each in dispersion in methyl ethyl ketone is, in the range of 400 nm or more and less than 600 nm for the pigment P1 and in the range of 600 nm or more and 700 nm or less for the pigment P2, the external additive contains titanium oxide, the content of the titanium oxide is 0.01% by mass or more and less than 1.00% by mass based on the total mass of the toner base particles, and the iron element content (atomic %) of the surface of the carrier as measured by X-ray electron spectroscopy satisfies the following expression (1):

Expression (1): 2≤{A_{Fe}/(A_{C}+A_{O}+A_{Fe})}×100≤20

wherein A_{Fe}, A_{C}, and A_{O} represent respectively the contents of Fe, C, and O (atomic %) per unit area of the carrier surface.

An image forming method using a two-component developer, includes: by use of the two-component developer according to the present invention as a two-component developer, attaching the electrostatic image developing toner contained in the two-component developer onto a recording medium; and fixing the electrostatic image developing toner attached to the recording medium.

### BRIEF DESCRIPTION OF THE DRAWING

The advantages and features provided by one or more embodiments of the invention will become more fully understood from the detailed description given hereinbelow and the appended drawings which are given by way of illustration only, and thus are not intended as a definition of the limits of the present invention. The figure shows a schematic configuration view illustrating an exemplary image forming apparatus 100 related to the present embodiment.

### DETAILED DESCRIPTION OF EMBODIMENTS

Hereinafter, one or more embodiments of the present invention will be described withe reference to the drawings. However, the scope of the invention is not limited to the disclosed embodiments.

The mechanism of development or action for the effects of the present invention has not been clarified, but is presumed to be as follows.

Herein, the “visible light region” refers to a region in which the wavelength of light (electromagnetic wave) is 400 nm or more and 800 nm or less, and the “near-infrared light region” refers to a region in which the wavelength of light (electromagnetic wave) is more than 800 nm and 2500 nm or less.

Recently, black toners having functionality have been being developed, and in particular, black toners having a function of transmitting near-infrared light are attracting attention. Images or the like including information imperceptible to the human eye embedded therein are expected to be formed by use of such toners.

A black colorant is usually used in black toners. However, conventionally known black colorants absorb not only visible light but also near-infrared light and thus cannot be used for the present object. Another method for producing a black toner is a method in which a plurality of colorants each having an absorption maximum wavelength in the visible light region is combined to cause the colorants to absorb light across the entire visible light region. Particularly, use of a colorant that has an absorption maximum wavelength in the visible light region and does not absorb (transmits) light in the near-infrared light region enables a toner of the present object to be obtained.

Use of a much amount of a colorant having an absorption maximum wavelength in the visible light region allows absorbability of visible light to be improved and black color developability to be improved. However, when a pigment to be used as a colorant is highly filled into a toner, the surface of the toner base particles (toner base particles will be described below) relatively hardens, and thus, the external additive is likely to be released and the amount of charge is likely to decrease over a long period of use.

Use of titanium oxide as the external additive of such a toner enables the fluidity of the toner to be improved. However, titanium oxide is generally used often as a white pigment, incorporation of titanium oxide may lower black color developability (image density) of the toner. Accordingly, the content of titanium oxide is limited to an extent such that sufficient color developability (image density) can be retained.

External addition of titanium oxide, which has low electric resistance, to the surface of toner base particles enables the resistance of the toner to be lowered, but, as mentioned above, the content of the titanium oxide is limited. Thus, the resistance cannot be sufficiently lowered, and the toner still has high resistance. In a two-component developer including a toner and a carrier, the carrier is preferably low-resistant in consideration of developability. In a long period of use, the external additive released from the toner may attach to the carrier, and the resistance of the carrier may increase. For this reason, the surface of the carrier is required to have a configuration that is low-resistant and to which the external additive is unlikely to attach.

Usually, a carrier takes a form in which the surface of a core material particles including a material having magnetic properties is coated with a resin. When the core material particles are sufficiently coated with a resin, the toner does not scatter, and thus a stable image density can be obtained. However, the core material particles including a material having magnetic properties, if completely coated with a resin, are not exposed, and thus the resistance of the carrier increases. For this reason, the carrier has to be coated with a resin such that the core material particles are moderately exposed.

The expression (1) above represents the relationship of the iron element content in the surface of the carrier. Predominant atoms in the carrier surface are carbon, oxygen, and iron. Carbon is derived mainly from the resin. In the present invention, an iron oxide based material is used for the carrier core material, and thus, iron is derived mainly from the core material. The expression (1) represents the proportion of iron among the predominant atoms (carbon, oxygen, and iron) in the carrier surface. Setting this proportion within a specific range causes the core material particles to be moderately exposed on the surface of the carrier.

Moderately providing irregularities in the profile of the surface of the carrier core material particles makes it difficult to evenly coat the particles with the resin, and thus the core material particles are likely to be exposed moderately on the carrier surface. Further, allowing the surface to have such a profile makes the external additive released from the toner unlikely to attach, and a desired carrier can be provided.

A two-component developer of the present invention is a two-component developer including an electrostatic image developing toner and a carrier, the electrostatic image developing toner containing toner particles having toner base particles and an external additive, wherein the toner base particles contain a colorant, the colorant contains a pigment P1 and a pigment P2, the absorption maximum wavelength 2max of the pigments P1 and P2 each in dispersion in methyl ethyl ketone is, in the range of 400 nm or more and less than 600 nm for the pigment P1 and in the range of 600 nm or more and 700 nm or less for the pigment P2, the external additive contains titanium oxide, the content of the titanium oxide is 0.01% by mass or more and less than 1.00% by mass based on the total mass of the toner base particles, and the iron element content (atomic %) of the surface of the carrier as measured by X-ray electron spectroscopy (XPS) satisfies the following expression (1):

Expression (1): 2≤{A_{Fe}/(A_{C}+A_{O}+A_{Fe})}×100≤20

wherein A_{Fe}, A_{C}, and A_{O} represent respectively the contents of Fe, C, and O (atomic %) per unit area of the carrier surface.

The characteristics are technical characteristics common to or corresponding to the following embodiments.

As an embodiment of the present invention, from the viewpoint of black color developability, it is preferred that the pigment P1 contain a pigment P1-2 and the absorption maximum wavelength λmax of the pigment P1-2 in dispersion in methyl ethyl ketone be within the range of 460 nm or more and 530 nm or less, and it is further preferred that the pigment P1-2 contain at least one pigment selected from the group consisting of C.I. Pigment Brown 23, C.I. Pigment Brown 25, C.I. Pigment Brown 41, and C.I. Pigment Red 38.

From the viewpoint of black color developability, the pigment P2 preferably contains at least one pigment selected from the group consisting of C.I. Pigment Blue 15, C.I. Pigment Blue 15:1, and the like.

From the viewpoint of black color developability, it is preferred that the pigment P1 contain a pigment P1-3 and the absorption maximum wavelength λmax (nm) of the pigment P1-3 in dispersion in methyl ethyl ketone be within the range of more than 530 nm and less than 600 nm, and it is further preferred that the pigment P1-3 contain at least one pigment selected from the group consisting of the pigments such as C.I. Pigment Orange 34 and C.I. Pigment Orange 36.

From the viewpoint of black color developability, it is preferred that the pigment P1 contains a pigment P1-1 and the absorption maximum wavelength λmax (nm) of the pigment P1-1 in dispersion in methyl ethyl ketone be within the range of 400 nm or more and less than 460 nm, and it is further preferred that the pigment P1-1 contain at least one pigment selected from the group consisting of the pigments such as C.I. Pigment Yellow 74 and C.I. Pigment Yellow 120.

From the viewpoint of low-temperature fixability, the toner base particles preferably contain crystalline polyester.

From the viewpoint of resistance of chargeability to environmental conditions, it is preferred that the carrier have a resin layer on at least the surface of the core material, and the resin contained in the resin layer contain a resin having a structural unit derived from an alicyclic (meth)acrylic ester, and it is further preferred that the content of the structural unit derived from an alicyclic (meth)acrylic ester in the resin contained in the resin layer is 50% by mass or more based on the total mass of the resin contained in the resin layer.

An image forming method of the present invention includes, by use the two-component developer of the present invention, attaching the electrostatic image developing toner contained in the two-component developer onto a recording medium; and fixing the electrostatic image developing toner attached to the recording medium.

Hereinafter, the present invention and components thereof, and embodiments and aspects for carrying out the present invention will be described in detail. In the present application, “to” is used as the meaning including the lower limit and the upper limit of the numerical value described before and after the term.

### Overview of the Two-Component Developer of the Present Invention

The two-component developer of the present invention is a two-component developer including an electrostatic image developing toner and a carrier, the electrostatic image developing toner containing toner particles having toner base particles and an external additive, wherein the toner base particles contain a colorant, the colorant contains a pigment P1 and a pigment P2, the absorption maximum wavelength 2max of the pigments P1 and P2 each in dispersion in methyl ethyl ketone is, in the range of 400 nm or more and less than 600 nm for the pigment P1 and in the range of 600 nm or more and 700 nm or less for the pigment P2, the external additive contains titanium oxide, the content of the titanium oxide is 0.01% by mass or more and less than 1.00% by mass based on the total mass of the toner base particles, and the iron element content (atomic %) of the surface of the carrier as measured by X-ray electron spectroscopy (XPS) satisfies the following expression (1):

Expression (1): 2≤{A_{Fe}/(A_{C}+A_{O}+A_{Fe})}×100≤20

wherein A_{Fe}, A_{C}, and A_{O} represent respectively the contents of Fe, C, and O (atomic %) per unit area of the carrier surface.

The toner according to the present invention is a black toner having a function of transmitting near-infrared light.

The toner, into which pigments are highly filled, is likely to have a lower amount of charge under high-temperature and high-humidity environment conditions. When the toner is combined with the carrier according to the present invention and used as a two-component developer, resistance of chargeability to environmental conditions can be obtained.

The electrostatic image developing toner according to the present invention is also simply referred to as the “toner”. The toner of the present invention includes toner particles including toner base particles and an external additive attached to the toner base particles surface.

The “toner base particles” herein constitutes the base for the “toner particles”. The “toner base particles” according to the present invention contains at least a colorant and may contain other constituents such as a mold-releasing agent (wax) and a charge controlling agent, as required. The “toner base particles” are referred to as “toner particles” after an external additive is added thereto. The “toner” refers to an assembly of toner particles.

### Electrostatic Image Developing Toner

[1. Toner Base Particles]

The toner base particles according to the present invention contains a colorant and preferably further contains a binding resin.

The average particle diameter on a volume basis of the toner base particles is preferably in the range of 5 to 8 μm and more preferably in the range of 5.5 to 7 μm. Setting the average particle diameter on a volume basis of the toner base particles to 5 μm or more enables the color developability to be favorable by sufficient internal addition of two or more pigments to the toner base particles and enables the transfer efficiency of the toner to be improved. Setting the average particle diameter on a volume basis of the toner base particles to 8 μm or less enables the resolution of an image to be formed to be further improved.

The average particle diameter on a volume basis of the toner base particles can be measured using a measuring apparatus in which a computer system into which data processing software: Software V3.51 is installed is connected to a particle size distribution analyzer (Multisizer 3 manufactured by Beckman Coulter, Inc.). Specifically, 0.02 g of a specimen (toner base particles) is added to 20 mL of a surfactant solution (e.g., a surfactant solution obtained by diluting a neutral detergent containing a surfactant component, for example, with pure water to 10 times for the purpose of dispersing the toner particles) and moistened therewith. Then the mixture is subjected to an ultrasonic dispersion treatment for one minute to prepare a dispersion liquid of the toner base particles. This resultant dispersion liquid is injected with a pipette to a beaker containing an electrolytic solution (ISOTON II manufactured by Beckman Coulter, Inc.) within a sample stand until the concentration displayed in the measuring apparatus reaches 8%. Setting to this concentration enables a reproducible measurement value to be obtained. Then, in the measuring apparatus, the count number of particles to be measured is set to 25000, and the aperture diameter is set to 100 μm. The measurement range of 2 to 60 μm is divided into 256 sections, a frequency value is calculated, and the average particle diameter on a volume basis is calculated based on the frequency value.

[1.1 Colorant]

The toner according to the present invention contains a colorant in toner base particles.

From the viewpoint of sufficient absorption of light of broader wavelengths in the visible light region, as the colorant, a pigment P1 having an absorption maximum wavelength λmax in the short wavelength-side region (region of 400 nm or more and less than 600 nm) when the visible light region (400 nm to 700 nm) is bisected, and a pigment P2 having an absorption maximum wavelength λmax in the long wavelength-side region (region of 600 nm or more and 700 nm or less) when the visible light region is bisected are used in combination.

Herein, as for the absorption maximum wavelength λmax of a pigment, 0.02 parts by mass of the pigment is mixed with respect to 100 parts by mass of methyl ethyl ketone, the resulting dispersion liquid is placed in a quartz cell for spectrophotometer having an optical path length of 10 mm, and the absorption spectrum is measured in a wavelength region of 400 to 700 nm. A value corresponding to the absorption maximum in the spectrum measured is taken as the absorption maximum wavelength λmax.

The pigment P1 can be further divided into a pigment P1-1 having an absorption maximum wavelength λmax within the range of 400 nm or more and less than 460 nm, a pigment P1-2 having an absorption maximum wavelength λmax within the range of 460 nm or more and 530 nm or less, and a pigment P1-3 having an absorption maximum wavelength λmax within the range of more than 530 nm and less than 600 nm. From the viewpoint that light of broader wavelengths in the visible light region can be sufficiently absorbed when the pigment P1 is combined with the pigment P2, the pigment P1 preferably contains the pigment P1-2.

From the similar viewpoint, the absorption maximum wavelength λmax of the pigment P1-1 is preferably within the range of more than 410 nm and less than 450 nm, the absorption maximum wavelength λmax of the pigment P1-2 is preferably within the range of 480 nm or more and 510 nm or less, the absorption maximum wavelength λmax of the pigment P1-3 is preferably within the range of more than 540 nm and less than 590 nm, and the absorption maximum wavelength λmax of the pigment P2 is preferably within the range of 620 nm or more and 660 nm or less.

The pigment P1-2 is a pigment having its absorption maximum wavelength λmax in the center (in the range of 460 nm or more and 530 nm or less) wavelength region of the wavelength region (400 nm to 600 nm) in which the pigment P1 may have its absorption maximum wavelength. A combination of the pigment P1-2 and the pigment P2 enables absorbability for light in the visible light region to be further improved. Additionally, the pigment P1-2, which is often a low-resistant pigment, is unlikely to cause decrease in the chargeability due to excess charging of the toner.

From the viewpoint that light of broader wavelengths can be sufficiently absorbed in the visible light region, the pigment P1-2 preferably has a half-value wavelength on the long wavelength side of the absorption spectrum of 550 nm or more.

The pigment P1-1 is not particularly limited as long as being a pigment having its absorption maximum wavelength within the range described above, and examples thereof include monoazo pigments, disazo pigments, benzimidazolone pigments, isoindolinone pigments, isoindoline pigment, and perinone pigments. Specific examples thereof include C.I. Pigment Yellow 1, C.I. Pigment Yellow 3, C.I. Pigment Yellow 12, C.I. Pigment Yellow 13, C.I. Pigment Yellow 14, C.I. Pigment Yellow 16, C.I. Pigment Yellow 17, C.I. Pigment Yellow 73, C.I. Pigment Yellow 74, C.I. Pigment Yellow 81, C.I. Pigment Yellow 83, C.I. Pigment Yellow 87, C.I. Pigment Yellow 97, C.I. Pigment Yellow 111, C.I. Pigment Yellow 120, C.I. Pigment Yellow 126, C.I. Pigment Yellow 127, C.I. Pigment Yellow 128, C.I. Pigment Yellow 139, C.I. Pigment Yellow 151, C.I. Pigment Yellow 154, C.I. Pigment Yellow 155, C.I. Pigment Yellow 173, C.I. Pigment Yellow 174, C.I. Pigment Yellow 175, C.I. Pigment Yellow 176, C.I. Pigment Yellow 180, C.I. Pigment Yellow 181, C.I. Pigment Yellow 185, C.I. Pigment Yellow 191, C.I. Pigment Yellow 194, C.I. Pigment Yellow 196, C.I. Pigment Yellow 213, C.I. Pigment Yellow 214, C.I. Pigment Yellow 217, C.I. Pigment Green 7, and C.I. Pigment Green 36. These may be used singly or in combination of two or more thereof.

Among these, C.I. Pigment Yellow 74, C.I. Pigment Yellow 120, C.I. Pigment Yellow 139, C.I. Pigment Yellow 151, C.I. Pigment Yellow 155, C.I. Pigment Yellow 180, C.I. Pigment Yellow 181, C.I. Pigment Yellow 185, C.I. Pigment Yellow 213, C.I. Pigment Green 7, and C.I. Pigment Green 36 are preferably used, from the viewpoint that favorable color developability and light resistance can be obtained.

The pigment P1-2 is not particularly limited as long as being a pigment having its absorption maximum wavelength within the range described above, and examples thereof monoazo pigments, disazo pigments, condensed azo pigments, naphthol AS pigments, and benzimidazolone pigments. Specific examples of the pigment P1-2 include C.I. Pigment Brown 23, C.I. Pigment Brown 25, C.I. Pigment Brown 41, and C.I. Pigment Red 38. These may be used singly or in combination of two or more thereof. These can be also preferably used in any case, from the viewpoint that favorable color developability and light resistance can be obtained.

The pigment P1-3 is not particularly limited as long as being a pigment having its absorption maximum wavelength within the range described above, and examples thereof include monoazo pigments, disazo pigments, β-naphthol pigments, naphthol AS pigments, azo lake pigments, benzimidazolone pigments, anthanthrone pigments, anthraquinone pigments, quinacridone pigments, dioxazine pigments, perylene pigments, thioindigo pigments, triarylcarbonium pigments, and diketopyrrolopyrrole pigments. Specific example thereof include C.I. Pigment Orange 5, C.I. Pigment Orange 13, C.I. Pigment Orange 34, C.I. Pigment Orange 36, C.I. Pigment Orange 38, C.I. Pigment Orange 43, C.I. Pigment Orange 62, C.I. Pigment Orange 68, C.I. Pigment Orange 70, C.I. Pigment Orange 72, C.I. Pigment Orange 74, C.I. Pigment Red 2, C.I. Pigment Red 3, C.I. Pigment Red 4, C.I. Pigment Red 5, C.I. Pigment Red 9, C.I. Pigment Red 12, C.I. Pigment Red 14, C.I. Pigment Red 31, C.I. Pigment Red 48:2, C.I. Pigment Red 48:3, C.I. Pigment Red 48:4, C.I. Pigment Red 53:1, C.I. Pigment Red 57:1, C.I. Pigment Red 112, C.I. Pigment Red 122, C.I. Pigment Red 144, C.I. Pigment Red 146, C.I. Pigment Red 147, C.I. Pigment Red 149, C.I. Pigment Red 150, C.I. Pigment Red 168, C.I. Pigment Red 169, C.I. Pigment Red 170, C.I. Pigment Red 175, C.I. Pigment Red 176, C.I. Pigment Red 177, C.I. Pigment Red 179, C.I. Pigment Red 181, C.I. Pigment Red 184, C.I. Pigment Red 185, C.I. Pigment Red 187, C.I. Pigment Red 188, C.I. Pigment Red 207, C.I. Pigment Red 208, C.I. Pigment Red 209, C.I. Pigment Red 210, C.I. Pigment Red 214, C.I. Pigment Red 238, C.I. Pigment Red 242, C.I. Pigment Red 247, C.I. Pigment Red 253, C.I. Pigment Red 254, C.I. Pigment Red 256, C.I. Pigment Red 257, C.I. Pigment Red 262, C.I. Pigment Red 263, C.I. Pigment Red 266, C.I. Pigment Red 269, C.I. Pigment Red 274, C.I. Pigment Violet 19, C.I. Pigment Violet 23, and C.I. Pigment Violet 32. These may be used singly or in combination of two or more thereof.

Among these, C.I. Pigment Orange 34, C.I. Pigment Orange 36, C.I. Pigment Orange 38, C.I. Pigment Orange 43, C.I. Pigment Orange 62, C.I. Pigment Orange 68, C.I. Pigment Orange 70, C.I. Pigment Orange 72, C.I. Pigment Orange 74, C.I. Pigment Red 31, C.I. Pigment Red 48:4, C.I. Pigment Red 57:1, C.I. Pigment Red 122, C.I. Pigment Red 146, C.I. Pigment Red 147, C.I. Pigment Red 150, C.I. Pigment Red 184, C.I. Pigment Red 238, C.I. Pigment Red 242, C.I. Pigment Red 254, C.I. Pigment Red 269, C.I. Pigment Violet 19, C.I. Pigment Violet 23, and C.I. Pigment Violet 32 are preferably used, from the viewpoint that favorable color developability and light resistance can be obtained.

From the viewpoint that light of broader wavelengths in the visible light region can sufficiently absorbed, the pigment P1 preferably contains any two or more of the pigment P1-1 to pigment P1-3 and more preferably contain all of these. When the toner base particles contain a greater variety of pigments, the charging stability is improved, and the fixability onto a recording medium is also improved. Further, even if any of the pigments is faded, other pigments can cover the wavelength region of the faded pigment, and thus, the light resistance of the formed image is also improved. Then, according to the findings of the present inventors, with more types of pigments, the dispersibility of the crystalline resin (particularly, crystalline polyester resin) is possibly enhanced, and the toner fixability is improved.

The pigment P2 is not particularly limited as long as being a pigment having its absorption maximum wavelength within the range described above, and examples thereof include C.I. C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 15:5, C.I. Pigment Blue 15:6, C.I. Pigment Blue 16, C.I. Pigment Blue 56, C.I. Pigment Blue 60, C.I. Pigment Blue 61, and C.I. Pigment Blue 80. These may be used singly or in combination of two or more thereof.

From the viewpoint of making the hue more favorable, improving the electrical conductivity and light resistance, and reducing decrease in the light transmission in the near-infrared light region, the pigment P2 is preferably a phthalocyanine pigment, and among these, C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 15:5, C.I. Pigment Blue 15:6, or C.I. Pigment Blue 16 is preferably used.

The total content of the pigments described above is preferably within the range of 1 to 30% by mass, more preferably within the range of 5 to 20% by mass, and further preferably within the range of 7 to 20% by mass, based on the total mass of the toner base particles. When the total content of the pigments is 1% by mass or more, the color developability of an image to be formed can be more favorable. When the total content of the pigments is 30% by mass or less, a sufficient amount of the binding resin can be contained in the toner base particles. Thus, the toner base particles become flexible, the fixability of an image can be sufficiently obtained, and titanium oxide is more unlikely to be released.

With respect to the content of each of the pigments, the total content of the pigment P1-2 and pigment P2 is preferably within the range of 60 to 100% by mass based on the sum of the total masses of the pigments, the content of the pigment P1-1 is preferably within the range of 0 to 40% by mass based on the sum of the total masses of the pigments, and the content of the pigment P1-3 is preferably within the range of 0 to 40% by mass based on the sum of the total masses of the pigments.

Further, the content of the pigment P1-2 is preferably within the range of 31 to 69% by mass, more preferably within the range of 35 to 65% by mass, and further preferably within the range of 40 to 60% by mass based on the sum of the total masses of the pigment P1-2 and the pigment P2. The content of the pigment P2 is preferably within the range of 31 to 69% by mass, more preferably within the range of 35 to 65% by mass, and further preferably within the range of 40 to 60% by mass based on the sum of the total masses of the pigment P1-2 and the pigment P2.

Carbon black, which is a black colorant that absorbs light in the visible light region, is likely to lower the light transmission in the near-infrared light region. Also having a high electrical conductivity, carbon black makes the chargeability of the toner unstable or fails to hold the charge to thereby leak the charge, and thus is likely to lower the dielectric loss tangent (transferability). From such viewpoints, the toner base particles preferably does not substantially contain carbon black. “Does not substantially contain” means that the content of carbon black is less than 1% by mass based on the sum of the total masses of the toner base particles and the external additive.

[1.2 Binding Resin]

The toner according to the present invention preferably contains a binding resin in the toner base particles.

The “binding resin (also referred to as the “binder resin”)” is a resin that is used as a medium or matrix (base) for dispersing an internal additive (such as wax, charge control agent, and pigment) and an external additive (such as silica and titanium oxide) contained in toner particles and has a function of allowing the toner to adhere to a recording medium (e.g., sheet) in a fixing treatment of a toner image.

From the viewpoint of immobilizing (fixing) the toner onto an image support (recording medium) such as paper with heat, the binding resin is preferably a thermoplastic resin.

The thermoplastic resin is not particularly limited as long as being a resin having the above function, and examples thereof include styrene resins, vinyl resins (such as acryl resins and styrene-acryl resin), polyester resins, silicone resins, olefin resins, polyamide resins, and epoxy resins. These may be used singly or in combination of two or more thereof.

The binding resin may be a crystalline resin or may be an amorphous resin.

[1.2.1 Crystalline Resin]

In the present invention, the “crystalline resin” refers to a resin not having a stepwise endothermic change but having a clear endothermic peak in a differential calorimetry curve determined by a differential scanning calorimeter (DSC). The clear endothermic peak specifically means a peak having a half-value width of the endothermic peak of 15° C. or less when measurement is performed at a temperature increase rate of 10° C./min in DSC measurement. A differential scanning calorimeter (Diamond DSC manufactured by PerkinElmer Co., Ltd.) is used for DSC measurement. The melting points of indium and zinc are used in a temperature correction of the detecting unit of this apparatus, and the melting heat of indium is used in a correction of a heat quantity.

In such a crystalline resin, due to its high crystallinity, its viscosity is high immediately before the melting temperature and abruptly drops off near the melting temperature (sharp melt property). Thus, when the binding resin contains a crystalline resin, there can be obtained a toner having high preservability under a high-temperature environment (heat-resistant storageability) and high fixability.

The melting point (Tm) of the crystalline resin is preferably within the range of 55 to 90° C. and more preferably within the range of 70 to 85° C., from the viewpoint of low-temperature fixability and hot offset resistance.

The melting point of the crystalline resin can be controlled with the composition of the resin.

The melting point (Tm), which is the peak top temperature of an endothermic peak, can be measured by DSC.

Specifically, a specimen is sealed in an aluminum pan KINTO. B0143013, the pan is set in a thermal analysis apparatus Diamond DSC (manufactured by PerkinElmer Co., Ltd.), and the temperature is changed in the order of heating, cooling, and heating. The temperature is raised from room temperature (25° C.) in the first heating and from 0° C. in the second heating at a temperature increase rate of 10° C./min to 150° C. and then kept at 150° C. for 5 minutes. In cooling, the temperature is lowered from 150° C. to 0° C. at a temperature decrease rate of 10° C./min and then kept at 0° C. for 5 minutes. The peak top temperature of the endothermic peak in the endothermic curve obtained in the second heating is measured as the melting point.

The content of the crystalline resin in the toner base particles is preferably within the range of 1 to 40% by mass and more preferably within the range of 5 to 30% by mass based on the total mass of the toner base particles, from the viewpoint of low-temperature fixability and heat-resistant storageability. When the content of the crystalline resin is 1% by mass or more, sufficient low-temperature fixability can be obtained, and when the content is 40% by mass or less, thermal stability and stability against physical stress for a toner, and heat-resistant storageability can be sufficiently obtained.

The content of the crystalline resin is preferably within the range of 2 to 20% by mass, more preferably within the range of 5 to 20% by mass, and further preferably within the range of 7 to 15% by mass based on the total mass of the binding resin, from the viewpoint of low-temperature fixability and heat resistance. When the content of the crystalline resin is 2% by mass or more, a sufficient plasticizing effect can be obtained, and low-temperature fixability is more marked, and when the content thereof is 20% by mass or less, the heat resistance is improved, and thermal stability and stability against physical stress for a toner, and heat-resistant storageability can be sufficiently obtained.

From the viewpoint of low-temperature fixability and gloss stability, the number average molecular weight (Mn) of the crystalline resin is preferably within the range of 3000 to 12500 and more preferably within the range of 4000 to 11000. The weight average molecular weight (Mw) of the crystalline resin is preferably within the range of 10000 to 100000, more preferably, within the range of 15000 to 80000, and further preferably within the range of 20000 to 50000.

When Mw and Mn are within the above ranges, the sharp melt property is likely to be developed, and the fixing temperature is easily controlled. Additionally, sufficient strength can be obtained in fixed images. On producing a toner, the crystalline resin is not pulverized during stirring of an emulsion, the glass transition temperature Tg of the toner is kept constant, and thus the thermal stability of the toner is maintained Mw and Mn can be determined from the molecular weight distribution measured by gel permeation chromatography (GPC) as described below.

(Method for Measuring Molecular Weight of Crystalline Resin)

A specimen is added to tetrahydrofuran (THF) at a concentration of 0.1 mg/mL, warmed to 40° C., and dissolved completely. Thereafter, the resulting solution is treated by a membrane filter having a pore size of 0.2 um, thereby preparing a specimen liquid (sample). Thereafter, measurement was conducted under the following conditions. In detail, a GPC apparatus HLC-8220GPC (manufactured by Tosoh Corporation) and a column “TSK gel Super H3000” (manufactured by Tosoh Corporation) are used to allow THF as a carrier solvent (eluent) to flow at a flow rate of 0.6 mL/min with the column temperature being kept at 40° C. Along with the carrier solvent, 100 μL of the specimen liquid prepared is injected into the GPC apparatus, and the specimen is detected using a differential refractive index detector (RI detector). Then, a calibration curve obtained by measurement at 10 points with respect to monodispersed polystyrene standard particles is used to calculate the molecular weight distribution of the specimen. If any peak derived from the filter is confirmed in data analysis, a region before the peak is set as the baseline, and data analyzed is taken as the molecular weight of the specimen.

Measurement model: GPC apparatus HLC-8220GPC manufactured by Tosoh Corporation

Column: “TSK gel Super H3000” manufactured by Tosoh Corporation

Eluent: THF

Temperature: column thermostat 40.0° C.

Flow rate: 0.6 ml/min

Concentration: 0.1 mg/mL (0.1 wt/vol%)

Calibration curve: standard polystyrene specimen manufactured by Tosoh Corporation

Amount injected: 100 μL

Solubility: complete dissolution (warmed at 40° C.)

Pre-treatment: filtration with a 0.2 μm filter

Detector: differential refractive index detector (RI)

Crystalline resins may be used singly or in combination of two or more thereof. The type of crystalline resins is not particularly limited, and examples thereof include crystalline polyolefin resins, crystalline polydiene resins, crystalline polyester resins, crystalline polyamide resins, crystalline polyurethane resins, crystalline polyacetal resins, crystalline polyethylene terephthalate resins, crystalline polybutylene terephthalate resins, crystalline polyphenylene sulfide resins, crystalline polyetheretherketone resins, and crystalline polytetrafluoroethylene resins. Among these, from the viewpoint of low-temperature fixability and gloss stability, crystalline polyester resins are preferred. A crystalline polyester resin, which melts on thermofixing to function as a plasticizer for amorphous resins, enables the low-temperature fixability to be improved.

From the viewpoint of low-temperature fixability and heat-resistant storageability, a crystalline polyester resin and an amorphous resin are preferably used in combination as the binding resin, and a crystalline polyester resin and a vinyl resin are more preferably used in combination.

[Crystalline Polyester]

The “crystalline polyester (hereinafter, also referred to as the “crystalline polyester resin”)” is a resin not having a stepwise endothermic change but having a clear endothermic peak in the differential scanning calorimetry (DSC) mentioned above, among known polyester resins obtained by a polycondensation reaction of a divalent or more carboxylic acid (polyvalent carboxylic acid) and a dihydric or more alcohol (polyhydric alcohol).

The crystalline polyester resin, which melts on thermofixing to function as a plasticizer for amorphous resins, also enables the low-temperature fixability of a toner to be improved. Such crystalline polyester resins may be used singly or in combination of two or more thereof.

The crystalline polyester resin is not particularly limited as long as being as defined above. For example, also with respect to a resin having a structure in which other components are copolymerized with the main chain of a crystalline polyester resin, the resin corresponds to the crystalline polyester resin referred to in the present invention as long as the resin shows a clear endothermic peak as mentioned above.

From the viewpoint of low-temperature fixability and gloss stability, the number average molecular weight (Mn) of the crystalline polyester resin is preferably within the range of 3000 to 12500 and more preferably within the range of 4000 to 11000. The weight average molecular weight (Mw) of the crystalline polyester resin is preferably within the range of 10000 to 100000, more preferably within the range of 12000 to 80000, and further preferably within the range of 14000 to 50000. Within the range described above, a toner to be obtained has a melting point within a preferable range, is excellent in blocking resistance, and also excellent in low-temperature fixability. The number average molecular weight (Mn) and weight average molecular weight (Mw) can be measured by the gel permeation chromatography (GPC) described above.

The acid value (AV) of the crystalline polyester resin is preferably from 5 to 70 mgKOH/g. The acid value can be measured in accordance with the method described in JIS K 2501:2003.

When the crystalline resin contained in the binding resin is a crystalline polyester resin, the content of the crystalline polyester resin is preferably within the range of 2 to 20% by mass, more preferably within the range of 5 to 20% by mass, and further preferably within the range of 7 to 15% by mass based on the total mass of the binding resin. A content of the crystalline polyester resin of 2% by mass or more results in excellent low-temperature fixability, and a content of 20% by mass or less results in excellent heat resistance.

The crystalline polyester resin is generated from a polyvalent carboxylic acid component and a polyhydric alcohol component. The valence of each of the polyvalent carboxylic acid component and polyhydric alcohol component is preferably from 2 to 3 and particularly preferably 2.

(Polyvalent Carboxylic Acid)

The “polyvalent carboxylic acid” is a compound having two or more carboxy groups in one molecule. Examples of the polyvalent carboxylic acid described above include dicarboxylic acids. Dicarboxylic acids may be used singly or in combination of two or more thereof. The dicarboxylic acid is preferably an aliphatic dicarboxylic acid and may further include an aromatic dicarboxylic acid. The aliphatic dicarboxylic acid is preferably a linear type, from the viewpoint of improving the crystallinity of the crystalline polyester resin.

Examples of the aliphatic dicarboxylic acid described above include saturated aliphatic dicarboxylic acids such as oxalic acid, malonic acid, succinic acid, glutaric acid, adipic acid (hexanedioic acid), pimelic acid, suberic acid (octanedioic acid), azelaic acid, sebacic acid (decanedioic acid), n-dodecylsuccinic acid, 1,9-nonanedicarboxylic acid, 1,10-decanedicarboxylic acid (dodecanedioic acid), 1,11-undecanedicarboxylic acid, 1,12-dodecanedicarboxylic acid (tetradecandioic acid), 1,13-tridecanedicarboxylic acid, 1,14-tetradecanedicarboxylic acid, 1,16-hexadecanedicarboxylic acid, and 1,18-octadecanedicarboxylic acid, lower alkyl esters thereof, and acid anhydrides thereof. Among these, from the viewpoint of achieving both low-temperature fixability and transferability, the aliphatic dicarboxylic acid is preferably an aliphatic dicarboxylic acid having 6 to 16 carbon atoms and more preferably an aliphatic dicarboxylic acid having 10 to 14 carbon atoms.

Examples of the aromatic dicarboxylic acid described above includes phthalic acid, terephthalic acid, isophthalic acid, orthophthalic acid, t-butyl isophthalic acid, 2,6-naphthalenedicarboxylic acid, and 4,4′-biphenyldicarboxylic acid. Among these, from the viewpoint of availability and ease of emulsification, terephthalic acid, isophthalic acid, or t-butyl isophthalic acid is preferred.

Examples of the polyvalent carboxylic acid also include, besides those described above, alicyclic dicarboxylic acids such as cyclohexanedicarboxylic acid, polyvalent carboxylic acids of trivalent or more such as trimellitic acid or pyromellitic acid; and anhydrides of these carboxylic acid compounds, or alkyl esters having 1 to 3 carbon atoms.

Such polyvalent carboxylic acids may be used singly or in combination of two or more thereof.

The content of the structural unit derived from the aliphatic dicarboxylic acid with respect to the structural unit derived from the dicarboxylic acids is preferably 50 mol % or more, more preferably 70 mol % or more, further preferably 80 mol % or more, and particularly preferably 100 mol %, from the viewpoint of the crystallinity of the crystalline polyester resin.

(Polyhydric Alcohol)

The “polyhydric alcohol” is a compound having two or more hydroxy groups in one molecule. Examples of the polyhydric alcohol component described above include diols. Diols may be used singly or in combination of two or more thereof. The diol is preferably an aliphatic diol and may include a diol other than those. The aliphatic diol is preferably a linear type, from the viewpoint of improving the crystallinity of the crystalline polyester resin.

Examples of the aliphatic diol include ethylene glycol, polypropylene glycol (1,2-propanediol), 1,3-propanediol, neopentyl glycol (2,2-dimethyl-1,3-propanediol), 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol. Among these, from the viewpoint of achieving both low-temperature fixability and transferability, the aliphatic diol is preferably an aliphatic diol having 2 to 20 carbon atoms and more preferably an aliphatic diol having 4 to 12 carbon atoms.

Examples of other diols include diols having a double bond and diols having a sulfonic acid group. Specifically, examples of diols having a double bond include 1,4-butenediol, 2-butene-1,4-diol, 3-butene-1,6-diol, and 4-butene-1,8-diol.

Examples of trivalent or more polyhydric alcohols include glycerin, pentaerythritol, trimethylolpropane, and sorbitol.

Polyhydric alcohols may be used singly or in combination of two or more thereof.

The content of the structural unit derived from the aliphatic diol with respect to the structural unit derived from the diols is preferably 50 mol % or more, more preferably 70 mol % or more, further preferably 80 mol % or more, and particularly preferably 100 mol %, from the viewpoint of low-temperature fixability and gloss stability.

The proportion of the diol to the dicarboxylic acid in the monomers constituting the crystalline polyester resin, that is, the equivalence ratio of hydroxy groups of the diol [—OH] to carboxy groups of the dicarboxylic acid [—COOH], [—OH]/[—COOH] is preferably within the range of 2.0/1.0 to 1.0/2.0, more preferably within the range of 1.5/1.0 to 1.0/1.5, and further preferably within the range of 1.3/1.0 to 1.0/1.3.

The monomers constituting the crystalline polyester resin contains preferably 50% by mass or more of a linear aliphatic monomer and more preferably 80% by mass or more of a linear aliphatic monomer. When a linear aliphatic monomer is used, the crystallinity of the crystalline polyester resin is high, and the melting point (the peak top temperature of the endothermic peak) is often high. When a branched aliphatic monomer is used, the crystallinity is low, and the melting point is also often low. Accordingly, a linear aliphatic monomer is preferably used as a monomer.

The crystalline polyester resin can be synthesized by polycondensing (esterifying) the polyvalent carboxylic acid and polyhydric alcohol described above by use of a known esterification catalyst.

Esterification catalysts may be used singly or in combination of two or more thereof. Examples thereof include alkali metal compounds such as sodium and lithium; compounds containing an element of the group 2 such as magnesium or calcium; compounds of metal such as aluminum, zinc, manganese, antimony, titanium, tin, zirconium, and germanium; phosphorous acid compounds; phosphoric acid compound; and amine compounds.

Specifically, examples of tin compounds include dibutyltin oxide, tin octylate, tin dioctylate, and salts thereof. Examples of titanium compounds include titanium alkoxides such as tetra-n-butyltitanate, tetraisopropyl titanate, tetramethyl titanate, and tetrastearyl titanate; titanium acylate such as polyhydroxy titanium stearate; and titanium chelates such as titanium tetraacetylacetonate, titanium lactate, and titanium triethanolaminate Examples of germanium compounds include germanium dioxide, and examples of aluminum compounds include oxides such as poly aluminum hydroxide, aluminum alkoxides, and tributyl aluminate.

The polymerization temperature of the crystalline polyester resin is preferably within the range of 150 to 250° C. The polymerization time is preferably within the range of 0.5 to 10 hours. During polymerization, the pressure inside the reaction system may be reduced.

Selection of the structure and constituent monomers of the crystalline polyester resin enables the degree of crystallinity and heat quantity of fusion of the crystalline polyester resin to be controlled. From the viewpoint of adjusting the degree of crystallinity of the crystalline polyester resin in a range preferable for fixing, the crystalline polyester resin is preferably a hybrid crystalline polyester resin described below. Hybrid crystalline polyester resins may be used singly or in combination of two or more thereof. The total amount or a portion of the crystalline polyester resin described above may be substituted with the hybrid crystalline polyester resin.

[Hybrid Crystalline Polyester Resin]

The crystalline resin according to the present invention is preferably a crystalline polyester resin. From the viewpoint of low-temperature fixability, the crystalline polyester resin is preferably a hybrid crystalline polyester resin including a crystalline polyester resin structure and an amorphous resin structure. Since the hybrid crystalline polyester resin includes an amorphous resin structure, compatibility with an amorphous resin increases, and a more finely disperse state can be maintained in the binding resin. Simultaneously, since the hybrid crystalline polyester resin includes a crystalline polyester resin structure, the sharp melt property of the crystalline resin is exerted on fixing, and the low-temperature fixability is improved. When the toner base particles has a core-shell structure, the core portion preferably contains the hybrid crystalline polyester resin, from the viewpoint that the crystalline polyester resin is more unlikely to be exposed on the surface of the toner base particles.

The hybrid crystalline polyester resin is a resin having a structure in which a crystalline polyester polymerization segment and an amorphous polymerization segment are chemically bonded to each other. The crystalline polyester polymerization segment means a portion derived from the crystalline polyester resin. That is, the crystalline polyester polymerization segment means a molecular chain having the same chemical structure as that of a molecular chain constituting the crystalline polyester resin mentioned above. The amorphous polymerization segment means a portion derived from the amorphous resin. That is, the amorphous polymerization segment means a molecular chain having the same chemical structure as that of a molecular chain constituting the amorphous resin described below.

The weight average molecular weight (Mw) of the hybrid crystalline polyester resin is preferably within the range of 20000 to 50000. When Mw is set to 50000 or less, sufficient low-temperature fixability can be obtained. Meanwhile, when Mw is set to 20000 or more, excessive progress in compatibilization of the hybrid resin and amorphous resin is reduced during storage of the toner, and image defects due to self-fusion of the toner can be reduced. The method for measuring the molecular weight of the crystalline resin mentioned above may be applied to measurement of the weight average molecular weight.

For the same reason, the number average molecular weight (Mn) of the hybrid crystalline polyester resin is preferably within the range of 3000 to 12500 and preferably within the range of 4000 to 11000.

When the crystalline resin contains a hybrid crystalline polyester resin, the content of the hybrid crystalline polyester resin is preferably within the range of 2 to 20% by mass, more preferably within the range of 5 to 20% by mass, and further preferably within the range of 7 to 15% by mass based on the total mass of the binding resin. When the content of the hybrid crystalline polyester resin is 2% by mass or more, the toner is excellent in low-temperature fixability, and when the content is 20% by mass or less, the toner is excellent in heat resistance.

The structure of the chemical bonding is not particularly limited, may be a block copolymer or a graft copolymer, but is preferably a structure in which a crystalline polyester polymerization segment is grafted on an amorphous polymerization segment as the main chain. That is, the hybrid crystalline polyester resin is preferably a graft copolymer having an amorphous polymerization segment as the main chain and a crystalline polyester polymerization segment as a side chain.

Hereinafter, a hybrid crystalline polyester resin having such a structure will be described.

(Crystalline Polyester Polymerization Segment)

The “crystalline polyester polymerization segment” refers to a portion derived from the crystalline polyester resin. That is, the crystalline polyester polymerization segment refers to a molecular chain having the same chemical structure as that constituting the crystalline polyester resin.

The crystalline polyester polymerization segment has the same meaning as that of the crystalline polyester resin mentioned above and is a portion derived from a known polyester resin obtained by a polycondensation reaction between a polyvalent carboxylic acid and a polyhydric alcohol. The crystalline polyester polymerization segment may be synthesized from a polyvalent carboxylic acid and a polyhydric alcohol in the same mariner as for the crystalline polyester resin mentioned above. The description of the polyvalent carboxylic acid component and polyhydric alcohol component constituting the crystalline polyester polymerization segment is omitted because of being the same as the contents of the “polyvalent carboxylic acid” and “polyhydric alcohol” sections explained in the crystalline polyester resin mentioned above.

The content of the crystalline polyester polymerization segment is preferably within the range of 80 to 98% by mass and more preferably within the range of 90 to 95% by mass based on the total mass of the hybrid crystalline polyester resin. When the content is within the range described above, sufficient crystallinity can be given to the hybrid crystalline polyester resin. The constituents and the content thereof of each segment in the hybrid crystalline polyester resin (or toner particles) can be identified by use of a known analysis method, for example, nuclear magnetic resonance (NMR) measurement or methylation reaction pyrolysis gas chromatography with mass spectrometry (Py-GC/MS).

The crystalline polyester polymerization segment preferably contains a monomer having an unsaturated bond, from the viewpoint of introducing a chemical bonding site with the amorphous polymerization segment into the segment. Monomers having an unsaturated bond are polyvalent carboxylic acids and polyhydric alcohols having a double bond, and examples thereof include polyvalent carboxylic acids such as methylene succinic acid, fumaric acid, maleic acid, 3-hexenedioic acid, and 3-octenedioic acid; and polyhydric alcohols such as 2-butene-1,4-diol, 3-butene-1,6-diol, and 4-butene-1,8-diol. The content of the structural unit derived from the monomer having an unsaturated bond in the crystalline polyester polymerization segment is preferably within the range of 0.5 to 20% by mass based on the total mass of the crystalline polyester polymerization segment.

A functional group such as a sulfonic acid group, a carboxy group, or a urethane group may be further introduced into the hybrid crystalline polyester resin. The functional group may be introduced into the crystalline polyester polymerization segment or into the amorphous polymerization segment.

(Amorphous Polymerization Segment)

The “amorphous polymerization segment” refers to a portion derived from the amorphous resin. That is, the amorphous polymerization segment refers to a molecular chain having the same chemical structure as that constituting the amorphous resin. The amorphous polymerization segment, when an amorphous resin is contained in the binding resin according to the present invention, enhances the compatibility of the hybrid crystalline polyester resin and the amorphous resin. For this reason, the hybrid crystalline resin is more likely to be taken into the amorphous resin, and the charging uniformity of the toner is further improved. The constituents of the amorphous polymerization segment in the hybrid crystalline polyester resin (or toner particles) and the content thereof can be identified by use of a known analysis method, for example, nuclear magnetic resonance (NMR) measurement or methylation reaction pyrolysis gas chromatography with mass spectrometry (Py-GC/MS).

The amorphous polymerization segment is a polymerization segment that does not exhibit a melting point and has a relatively high glass transition temperature (Tg) when a resin having the same chemical structure and molecular weight is subjected to differential scanning calorimetry (DSC). The amorphous polymerization segment, similarly as the amorphous resin, has a glass transition temperature (Tg) in the first temperature increase process of DSC preferably within the range of 30 to 80° C. and more preferably within the range of 40 to 65° C. The glass transition temperature (Tg) can be measured in the same manner as for the Tg of the amorphous resin.

The amorphous polymerization segment is preferably including a resin of the same type as the amorphous resin (e.g., vinyl resin) contained in the binding resin, from the viewpoint of improving the compatibility with the binding resin and improving the charging uniformity of the toner. When the segment has such a form, the compatibility of the hybrid crystalline polyester resin and the amorphous resin is further improved. The phrase “resins of the same type” means resins each having a characteristic chemical bond in the repeating unit.

The “characteristic chemical bond” conforms to “Polymer Classification” indicated in the National Institute for Material Science (NIMS) Materials Database:

(http://polymer.nims.go.Jp/PoLyInfo/guide/jp/term_polymer.html). That is, the chemical bonds that constitute the following 22 types of polymers are called as “characteristic chemical bonds”: polyacryls, polyamides, polyacid anhydrides, polycarbonates, polydienes, polyesters, poly-halo-olefins, polyimides, polyimines, polyketones, polyolefins, polyethers, polyphenylenes, polyphosphazenes, polysiloxanes, polystyrenes, polysulfides, polysulfones, polyurethanes, polyureas, polyvinyls, and other polymers.

The phrase “resins of the same type” in the case where the resins are copolymers means resins having a characteristic chemical bond in common, when the monomers having the chemical bonds described above are included as constituting units in the chemical structure of a plurality of monomers that constitutes the copolymer. Accordingly, even if the resins each have a different property from each other, and even if the resins each have a different molar ratio of the monomers which constitute the copolymers, the resins are considered to be the resins of the same type as long as the resins have a characteristic chemical bond in common.

For example, the resin (or polymerization segment) formed with styrene, butyl acrylate, and acrylic acid and the resin (or polymerization segment) formed with styrene, butyl acrylate, and methacrylic acid both have at least a chemical bond constituting a polyacrylate, and thus, these are the resins of the same type. By way of further examples, the resin (or polymerization segment) formed with styrene, butyl acrylate, and acrylic acid and the resin (or polymerization segment) formed with styrene, butyl acrylate, acrylic acid, terephthalic acid, and fumaric acid both have at least a chemical bond constituting polyacrylate as a chemical bond common to each other. Thus, these are resins of the same type.

From the viewpoint of introducing a chemical bonding site with the crystalline polyester polymerization segment into the amorphous polymerization segment, the amorphous polymerization segment preferably contains an amphoteric compound described below as a monomer. The content of the structural unit derived from the amphoteric compound is preferably within the range of 0.5 to 20% by mass based on the total mass of the amorphous polymerization segment.

From the viewpoint of giving sufficient crystallinity to the hybrid crystalline polyester resin, the content of the amorphous polymerization segment is preferably within the range of 2 to 20% by mass, more preferably within the range of 3 to 15% by mass, further preferably within the range of 5 to 10% by mass, and particularly preferably within the range of 7 to 9% by mass based on the total mass of the hybrid crystalline polyester resin.

The resin component constituting the amorphous polymerization segment is not particularly limited, and examples thereof include a vinyl polymerization segment, a urethane polymerization segment, and a urea polymerization segment. Among these, a vinyl polymerization segment is preferred from the viewpoint of thermoplasticity.

When a vinyl polymerization segment is used, a vinyl resin is preferably used as the amorphous resin in the binding resin, and further, a vinyl resin is preferably contained in the largest proportion in the binding resin. This allows the compatibility of the vinyl polymerization segment and the vinyl resin to be improved, the hybrid crystalline polyester resin can maintain a finely dispersed state in the binding resin, and the sharp melt property of the crystalline resin is more likely to be exerted during fixing. The vinyl polymerization segment may be synthesized in the same manner as for the vinyl resin.

The vinyl polymerization segment is not particularly limited as long as being obtained by polymerizing a vinyl compound, and examples thereof include an acrylic ester polymerization segments, styrene-acrylic ester polymerization segments, and ethylene-vinyl acetate polymerization segments. These may be used singly or in combination of two or more thereof.

In consideration of the thermoplasticity during thermofixing, styrene-acrylic ester polymerization segments (also simply referred to as “styrene-aml polymerization segments”) are preferred among the vinyl polymerization segments described above. Thus, hereinafter, a styrene-acryl polymerization segment as an amorphous polymerization segment will be described.

(Styrene-Acryl Polymerization Segment)

A styrene-acryl polymerization segment is formed by addition-polymerizing at least a styrene monomer and a (meth)acrylic ester monomer. A styrene monomer referred to herein include, in addition to styrene represented by the structural formula: CH₂═CH—C₆H₅, structures having a known side chain or functional group in the styrene structure. A (meth)acrylic ester monomer referred to herein includes, in addition to acrylic ester compound represented by CH₂═CHCOOR (R represents an alkyl group) and a methacrylic ester compound, ester compounds having a known side chain or functional group in a structure such as acrylic ester derivatives and methacrylic ester derivatives.

Hereinafter, specific examples of the styrene monomer and (meth)acrylic ester monomer that can form a styrene-acryl polymerization segment, are listed, but those that can be used for forming a styrene-acryl polymerization segment for use in the present invention are not limited to the following.

(Styrene Monomer)

Specific examples of the styrene monomer include styrene, o-methylstyrene, m-methylstyrene, p-methylstyrene, x-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecylstyrene. These styrene monomers may be used singly or in combination of two or more thereof.

((Meth)Acrylic Ester Monomer)

Specific examples of the (meth)acrylic ester monomer include acrylic ester monomers such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, and phenyl acrylate; and methacrylic esters such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate. Among these, a long chain acrylic ester monomer is preferably used. Specifically, methyl acrylate, n-butyl acrylate, and 2-ethylhexyl acrylate are preferred.

The “(meth)acrylic ester monomer” herein is a generic term for an “acrylic ester monomer” and a “methacrylic ester monomer”, and for example, “methyl (meth)acrylate” is a generic term for “methyl acrylate” and “methyl methacrylate”.

These acrylic ester monomers or methacrylic ester monomers may be used singly or in combination of two or more thereof. That is, any of forming a copolymer by using a styrene monomer and two or more acrylic ester monomers, forming a copolymer by using a styrene monomer and two or more methacrylic ester monomers, or forming a copolymer by using a styrene monomer in combination with an acrylic ester monomer and a methacrylic ester monomer can be performed.

The content of the structural unit derived from the styrene monomer in the styrene-acryl polymerization segment is preferably within the range of 40 to 90% by mass based on the total mass of the styrene-acryl polymerization segment, from the viewpoint of plasticity. From the similar viewpoint, the content of the structural unit derived from the (meth)acrylic ester monomer in the styrene-acryl polymerization segment is preferably within the range of 10 to 60% by mass based on the total mass of the styrene-acryl polymerization segment.

The styrene-acryl polymerization segment is preferably formed by addition-polymerizing a compound to be chemically bonded to the above-described crystalline polyester polymerization segment, in addition to the above-described styrene monomer and (meth)acrylic ester monomer. Specifically, preferably used is a compound to be ester-bonded to a hydroxyl group [—OH] derived from a polyhydric alcohol component or a carboxy group [—COOH] derived from a polyvalent carboxylic acid component, contained in the crystalline polyester polymerization segment. Accordingly, the styrene-acryl polymerization segment is preferably formed by further polymerizing a compound that can be addition-polymerized to the styrene monomer and the (meth)acrylic ester monomer and has a carboxy group [—COOH] or a hydroxy group [—OH].

Examples of such compounds include a compound having a carboxy group, such as acrylic acid, methacrylic acid, maleic acid, itaconic acid, cinnamic acid, fumaric acid, maleic acid monoalkyl ester, and itaconic acid monoalkyl ester; and a compound having a hydroxy group, such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, and polyethylene glycol mono(meth)acrylate.

The content of the structural unit derived from the above-described compound in the styrene-acryl polymerization segment is preferably within the range of 0.5 to 20% by mass based on the total mass of the styrene-acryl polymerization segment, from the viewpoint of introducing a chemical bonding site with the above-described crystalline polyester polymerization segment into the styrene-acryl polymerization segment.

A method for forming a styrene-acryl polymerization segment is not particularly limited, and an example thereof is a method in which monomers are polymerized by using a known oil-soluble or water-soluble polymerization initiator. Specific examples of the oil-soluble polymerization initiator include azo-based or diazo-based polymerization initiators and peroxide-based polymerization initiators as follows.

(Azo-based or Diazo-based Polymerization Initiator)

Examples of the azo-based or diazo-based polymerization initiator include 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile.

(Peroxide-based Polymerization Initiator)

Examples of the peroxide-based polymerization initiator include benzoyl peroxide, methyl ethyl ketone peroxide, diisopropyl peroxycarbonate, cumene hydroperoxide, t-butyl hydroperoxide, di-t-butyl peroxide, t-butyl peroxypivalate, dicumyl peroxide, 2,4-dichlorobenzoyl peroxide, lauroyl peroxide, 2,2-bis-(4,4-t-butylperoxycyclohexyl) propane, and tris-(t-butylperoxy)triazine.

In the case where resin particles are formed by an emulsion polymerization method, a water-soluble radical polymerization initiator can be used. Examples of the water-soluble radical polymerization initiator include persulfates such as potassium persulfate and ammonium persulfate, azobisaminodipropane acetate, azobiscyanovaleric acid and salts thereof, and hydrogen peroxide.

(Method for Producing Hybrid Crystalline Polyester Resin)

A method for producing a hybrid crystalline polyester resin is not particularly limited as long as the method can form a polymer having a structure in which a crystalline polyester polymerization segment and an amorphous polymerization segment are chemically bonded. As a specific method for producing a hybrid crystalline polyester resin, the resin can be produced by, for example, first to third production methods described below.

(First Production Method)

A first method is a method in which, in the presence of a preliminarily synthesized amorphous polymerization segment, a polymerization reaction to synthesize a crystalline polyester polymerization segment is conducted to produce a hybrid crystalline polyester resin.

(Second Production Method)

A second production method is a method in which a crystalline polyester polymerization segment and an amorphous polymerization segment each are formed in advance and bonded with each other to produce a hybrid crystalline polyester resin.

(Third Production Method)

A third method is a method in which, in the presence of a crystalline polyester polymerization segment, a polymerization reaction to synthesis an amorphous polymerization segment is conducted to produce a hybrid crystalline polyester resin.

Among the first to third methods described above, the first production method is preferable because a hybrid crystalline polyester resin having a structure in which a crystalline polyester polymerization chain (crystalline polyester resin chain) is grafted to an amorphous polymerization chain (amorphous resin chain) is easily synthesized and the production step can be simplified. In the first production method, the amorphous polymerization segment is preliminarily formed, and then the crystalline polyester polymerization segment is bonded. Thus, orientation of the crystalline polyester polymerization segment is likely to be uniform. Accordingly, the method is preferred from the viewpoint that a hybrid crystalline polyester resin suitable for the toner of the present invention is easily synthesized.

[1.2.2 Amorphous Resin]

The toner according to the present invention base particles preferably contains an amorphous resin as the binding resin, in addition to the crystalline resin. The amorphous resin is a resin that does not have the “crystallinity” mentioned above, and incorporation of the amorphous resin in the toner base particles allows the crystalline resin and the amorphous resin to be compatible during heat fixing, and thus the low-temperature fixability of the toner is improved.

That is, the “amorphous resin” is a resin that does not have a melting point in an endothermic curve obtained when subjected to differential scanning calorimetry (DSC) (i.e., does not have the clear endothermic peak mentioned above during temperature increase) and has a relatively high glass transition temperature (Tg).

In the present invention, the Tg of the amorphous resin is preferably within the range of 35 to 80° C. and more preferably within the range of 45 to 65° C.

From the viewpoint of simultaneously achieving all of low-temperature fixability, hot offset resistance, and heat resistance, the toner base particles preferably have a core-shell structure. When mold-releasing agent (wax)-containing amorphous resin (e.g., mold-releasing agent-containing amorphous vinyl resin) particles having a 3-ply structure are contained in the core portion of the core-shell structure, the Tg of the amorphous resin constituting the outermost layer of the particles is preferably within the range of 55 to 65° C.

The glass transition temperature described above can be measured in accordance with the method specified in ASTM D3418-82 (DSC method). For the measurement, a DSC-7 differential scanning calorimeter (manufactured by PerkinElmer Co., Ltd.), a TAC7/DX thermal analysis apparatus controller (manufactured by PerkinElmer Co., Ltd.), or the like can be used.

The weight average molecular weight (Mw) of the amorphous resin is preferably within the range of 20000 to 150000 and more preferably within the range of 25000 to 130000, from the viewpoint of plasticity. The number average molecular weight (Mn) of the amorphous resin is preferably within the range of 5000 to 150000 and more preferably within the range of 8000 to 70000, from the viewpoint of plasticity. The molecular weight of the amorphous resin can be measured in the same manner as in the method for measuring the molecular weight of the crystalline resin mentioned above.

The mass ratio of the amorphous resin to the crystalline resin (amorphous resin/crystalline resin) is preferably within the range of 98/2 to 80/20 and more preferably within the range of 95/5 to 80/20. When the mass ratio is within the range described above, the crystalline resin is not exposed on the surface of the toner base particles, or if exposed, the amount exposed is extremely small, and the crystalline resin in an amount that enables low-temperature fixability to be achieved can be introduced into the toner particles.

The amorphous resin is preferably used along with the crystalline resin described above as the binding resin to constitute the toner base particles. When the amorphous resin is contained, moderate fixed image strength and image gloss can be obtained as well as favorable charging properties can be given even under an environment where the temperature and humidity vary.

When the toner according to the present invention base particles has a core-shell structure, from the viewpoint of controllability of the dispersion state in the toner base particles and charging properties, the amorphous vinyl resin and the crystalline polyester resin preferably constitute the core portion, and the hybrid amorphous polyester resin preferably constitutes the shell layer.

Amorphous resins may be used singly or in combination of two or more thereof. Examples of the amorphous resin include amorphous polyester resins such as vinyl resins, urethane resins, urea resins, and styrene-acryl-modified polyester resins. The amorphous resin preferably contains an amorphous vinyl resin (also simply referred to as a vinyl resin) from the viewpoint of thermoplasticity. These amorphous resins can be obtained by a known synthesis method or as commercially available products.

Hereinafter, vinyl resins will be described.

(Vinyl Resin)

The main component of the binding resin according to the present invention is preferably a vinyl resin. When a vinyl resin is the main component, the compatibility/incompatibility between the crystalline resin and the amorphous resin is easily adjusted, and the crystalline polyester resin can maintain its more finely dispersed state in the binding resin, particularly in the vinyl resin as the main component. Thus, the sharp melt property of the crystalline polyester resin is more exerted during fixing.

The content of the vinyl resin is preferably 50% by mass or more, more preferably 70% by mass or more, further preferably 80% by mass or more, and particularly preferably 85% by mass or more based on the total mass of the binding resin. When the vinyl resin is the main component (50% by mass or more based on the total mass of the binding resin), the compatibility with the crystalline resin is easily adjusted, and both the low-temperature fixability and heat resistance can be achieved. The upper limit of the content of the vinyl resin is not particularly limited, and is preferably 98% by mass or less, more preferably 95% by mass or less, and further preferably 93% by mass or less based on the total mass of the binding resin.

The binding resin according to the present invention preferably contains a vinyl resin as the main component and further contains an amorphous polyester resin. This is because incorporation of the amorphous polyester resin allows the compatibility with the crystalline resin to be more easily adjusted.

When the toner base particles has a core-shell structure, the amorphous polyester resin has more excellent heat resistance than that of the vinyl resin. Thus, providing a shell layer including the amorphous polyester resin enables both the heat resistance and low-temperature fixability of the toner to be achieved. From such viewpoints, the content of the amorphous polyester resin is preferably within the range of 2 to 20% by mass, more preferably within the range of 3 to 18% by mass, and further preferably within the range of 4 to 15% by mass based on the total mass of the binding resin.

In the present invention, the vinyl resin is, for example, a polymer of a vinyl compound, and examples thereof include acrylic ester resins, styrene-acrylic ester resins, and ethylene-vinyl acetate resins. These may be used singly or in combination of two or more thereof. Among these, the styrene-acrylic ester resin (styrene-acryl resin) is preferred from the viewpoint of plasticity during thermofixing. As the styrene monomer and the (meth)acrylic ester monomer used in the styrene-acryl resin, the same ones as in the contents explained in the “Styrene Monomer” and “(Meth)acrylic Ester Monomer” sections mentioned above may be used.

The styrene-acryl resin is formed by addition-polymerizing at least a styrene monomer and a (meth)acrylic ester monomer. The styrene monomer include, in addition to styrene represented by the structural formula: CH₂═CH—C₆H₅, styrene derivatives having a known side chain or functional group in the styrene structure.

The (meth)acrylic ester monomer include, in addition to acrylic esters and methacrylic esters represented by CH(R₁)═CHCOOR₂ (R₁ represents a hydrogen atom or a methyl group, and R2 represents an alkyl group having 1 to 24 carbon atoms), acrylic ester derivatives and methacrylic ester derivatives, which have a known side chain or functional group in the structure of such esters.

Examples of the styrene monomer include styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecylstyrene.

Examples of the (meth)acrylic ester monomer include acrylic ester monomers such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, and phenyl acrylate; and methacrylic ester monomers such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate.

The “(meth)acrylic ester monomer” herein is a generic term for an “acrylic ester monomer” and a “methacrylic ester monomer”, meaning one or both of them. For example, “methyl meth(acrylate)” means one or both of “methyl acrylate” and “methyl methacrylate”.

The (meth)acrylic ester monomers described above may be used singly or in combination of two or more thereof. For example, any of forming a copolymer by using a styrene monomer and two or more acrylic ester monomers, forming a copolymer by using a styrene monomer and two or more methacrylic ester monomers, and forming a copolymer by using a styrene monomer in combination with an acrylic ester monomer and a methacrylic ester monomer can be performed.

From the viewpoint of plasticity, the content of the structural unit derived from the styrene monomer is preferably within the range of 40 to 90% by mass based on the total mass of the amorphous resin. The content of the structural unit derived from the (meth)acrylic ester monomer is preferably within the range of 10 to 60% by mass based on the total mass of the amorphous resin.

The amorphous resin may further contain a structural unit derived from a monomer other than the styrene monomers and (meth)acrylic ester monomers described above. The other monomer is preferably a compound to be ester-bonded to a hydroxy group [—OH] derived from a polyhydric alcohol or a carboxy group [—COOH] derived from a polyvalent carboxylic acid. That is, the amorphous resin is preferably a polymer formed by further polymerizing a compound that can be addition-polymerized to the styrene monomer and the (meth)acrylic ester monomer described above and is amphoteric (compound having a carboxy group or a hydroxy group).

The “amphoteric compound” in the present invention is a monomer that binds a crystalline polyester polymerization segment to an amorphous polymerization segment. The monomer includes a substituent that may react with a crystalline polyester polymerization segment such as a hydroxy group, a carboxy group, an epoxy group, a primary amino group, or a secondary amino group, and an ethylenic unsaturated group that may react with an amorphous polymerization segment in the molecule. In particular, a vinylcarboxylic acid having a hydroxy group or a carboxy group and an ethylenic unsaturated group is preferred.

Examples of the amphoteric compounds described above include a compound having a carboxy group, such as acrylic acid, methacrylic acid, maleic acid, itaconic acid, cinnamic acid, fumaric acid, maleic acid monoalkyl ester, and itaconic acid monoalkyl ester; and a compound having a hydroxy group, such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, and polyethylene glycol mono(meth)acrylate.

The content of the structural unit derived from the amphoteric compound is preferably within the range of 0.5 to 20% by mass based on the total mass of the amorphous resin.

The styrene-acryl resin described above can be synthesized by a method for polymerizing a monomer using a known oil-soluble or water-soluble polymerization initiator. Examples of the oil-soluble polymerization initiator include azo-based or diazo-based polymerization initiators and peroxide-based polymerization initiators. Specifically, since the initiators are the same as in the method for forming a styrene-acryl polymerization segment mentioned above, the description thereof is omitted here.

The weight average molecular weight (Mw) of the amorphous vinyl resin is preferably within the range of 20000 to 150000, and the number average molecular weight (Mn) thereof is preferably within the range of 5000 to 150000, from the viewpoint of achieving both low-temperature fixability and hot offset resistance. The weight average molecular weight (Mw) and the number average molecular weight (Mn) can be measured in the same manner as for the crystalline resin mentioned above.

The glass transition temperature (Tg) of the amorphous vinyl resin is preferably within the range of 35 to 80° C. from the viewpoint of achieving both fixability and hot offset resistance. The glass transition temperature can be measured in the same manner as in the case of the amorphous resin mentioned above.

(Hybrid Amorphous Polyester Resin)

The binding resin according to the present invention preferably contains a hybrid amorphous polyester resin from the viewpoint of moderate compatibility to be obtained when in use in combination with an amorphous vinyl resin, the shape controllability of the toner base particles, and the fixed image strength. When a hybrid amorphous polyester resin is contained, compatibility/incompatibility and crystallinity will be easily adjusted. The hybrid amorphous polyester resin can also be said as a modified amorphous polyester resin that has been partially modified.

The weight average molecular weight (Mw) of the hybrid amorphous polyester resin is preferably within the range of 20000 to 50000. When the Mw is within the range described above, compatibility/incompatibility and crystallinity are more easily adjusted. The number average molecular weight (Mn) of the hybrid amorphous polyester resin is preferably within the range of 3000 to 12500. The molecular weight can be measured in the same manner as for the crystalline resin mentioned above.

The hybrid amorphous polyester resin is a resin obtained by chemically bonding an amorphous polyester polymerization segment with an amorphous polymerization segment other than amorphous polyester, preferably an amorphous vinyl polymerization segment.

The amorphous polyester polymerization segment refers to a portion derived from an amorphous polyester resin. That is, the amorphous polyester polymerization segment refers to a molecular chain having the same chemical structure as that constituting the amorphous polyester resin. The amorphous polymerization segment other than amorphous polyester refers to a portion derived from an amorphous resin other than an amorphous polyester resin. Examples of the amorphous resin other than an amorphous polyester resin include vinyl resins such as styrene-acryl resin, urethane resins, and urea resins. Such amorphous polymerization segments other than amorphous polyester may be used singly or in combination of two or more thereof.

Accordingly, a preferable amorphous vinyl polymerization segment refers to a portion derived from an amorphous vinyl resin. That is, the amorphous vinyl polymerization segment refers to a molecular chain having the same chemical structure as that constituting the amorphous vinyl resin.

The hybrid amorphous polyester resin may be of any form such as a block copolymer and a graft copolymer as long as the resin contains an amorphous polyester polymerization segment and an amorphous polymerization segment other than amorphous polyester, particularly an amorphous vinyl polymerization segment, and is preferably a graft copolymer. When the resin is a graft copolymer, low-temperature fixability, hot offset resistance, and mold releasability can be simultaneously achieved.

Further, from the viewpoints described above, preferred is a structure in which an amorphous polyester polymerization segment is grafted to an amorphous polymerization segment other than amorphous polyester, particularly an amorphous vinyl polymerization segment as the main chain. That is, the hybrid amorphous polyester resin is preferably a graft copolymer having an amorphous polymerization segment other than amorphous polyester, particularly an amorphous vinyl polymerization segment as the main chain and having an amorphous polyester polymerization segment as a side chain.

The content of the hybrid amorphous polyester resin is preferably within the range of 3 to 20% by mass and more preferably within the range of 5 to 15% by mass based on the total mass of the binding resin.

(Amorphous Polyester Polymerization Segment)

An amorphous polyester polymerization segment refers to a polymerization segment that is a portion derived from a known polyester resin obtained by a polycondensation reaction of a divalent or more carboxylic acid (polyvalent carboxylic acid component) and a dihydric or more alcohol (polyhydric alcohol component), the segment having no clear endothermic peak observed in DSC.

The amorphous polyester polymerization segment is not particularly limited as long as the segment is as defined above. For example, a resin having a structure in which a main chain composed of an amorphous polyester polymerization segment is copolymerized with another component or a resin having a structure in which an amorphous polyester polymerization segment is copolymerized with a main chain including another component, as long as having no clear endothermic peak of the resin observed as described above, corresponds to a hybrid amorphous polyester resin having an amorphous polyester polymerization segment in the present invention.

(Polyvalent Carboxylic Acid Component)

Examples of polyvalent carboxylic acid components include dicarboxylic acids such as oxalic acid, succinic acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-dicarboxylic acid, malic acid, citric acid, hexahydroterephthalic acid, malonic acid, pimelic acid, tartaric acid, mucic acid, phthalic acid, isophthalic acid, terephthalic acid, tetrachlorophthalic acid, chlorophthalic acid, nitrophthalic acid, p-carboxyphenylacetic acid, p-phenylenediacetic acid, m-phenylenediglycolic acid, p-phenylenediglycolic acid, o-phenylenediglycolic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, and dodecenylsuccinic acid; trimellitic acid, pyromellitic acid, naphthalenetricarboxylic acid, naphthalenetetracarboxylic acid, pyrenetricarboxylic acid, and pyrenetetracarboxylic acid. These polyvalent carboxylic acids may be used singly or in combination of two or more thereof.

Among these, from the viewpoint that effects of the invention are easily obtained, an aliphatic unsaturated dicarboxylic acid such as fumaric acid, maleic acid, or mesaconic acid, or an aromatic dicarboxylic acid such as isophthalic acid or terephthalic acid, succinic acid, or trimellitic acid is preferably used.

(Polyhydric Alcohol Component)

Examples of polyhydric alcohol components include dihydric alcohols such as ethylene glycol, polypropylene glycol, butanediol, diethylene glycol, hexanediol, cyclohexanediol, octanediol, decanediol, dodecanediol, ethylene oxide adducts of bisphenol A, and propyleneoxide adducts of bisphenol A; and trihydric or more polyols such as glycerin, pentaerythritol, hexamethylolmelamine, hexaethylolmelamine, tetramethylolbenzoguanamine, and tetraethylolbenzoguanamine These polyhydric alcohol components may be used singly or in combination of two or more thereof.

Among these, dihydric alcohols such as ethylene oxide adducts of bisphenol A, and propylene oxide adducts of bisphenol A are preferred from the viewpoint that effects of the present invention are easily obtained.

The use ratio of the polyvalent carboxylic acid component and the polyhydric alcohol component described above is, in the equivalence ratio of the hydroxy group [—OH] of the polyhydric alcohol component to the carboxy group [—COOH] of the polyvalent carboxylic acid component, [—OH]/[—COOH], preferably within the range of 1.5/1 to 1/1.5 and more preferably within the range of 1.2/1 to 1/1.2. When the use ratio of the polyhydric alcohol component and the polyvalent carboxylic acid component is within the range described above, the acid value and the molecular weight of the amorphous polyester resin are more easily controlled.

A method for forming an amorphous polyester polymerization segment is not particularly limited, and the polymerization segment can be formed by polycondensing (esterifying) the polyvalent carboxylic acid and polyhydric alcohol described above by use of a known esterification catalyst.

Catalysts that can be used for production of an amorphous polyester polymerization segment are the same as the catalysts described in the (Crystalline Resin) section described above, and thus the description thereof is omitted here.

The polymerization temperature is not particularly limited and is preferably within the range of 150 to 250° C. The polymerization time is not particularly limited and is preferably within the range of 0.5 to 10 hours. During polymerization, the pressure inside the reaction system may be reduced.

The content of the amorphous polyester polymerization segment in the hybrid amorphous polyester resin is preferably within the range of 50 to 99.9% by mass and more preferably within the range of 70 to 95% by mass based on the total mass of the hybrid amorphous polyester resin. When the content thereof is within the range described above, both heat resistance and low-temperature fixability can be achieved. The constituent and content of each polymerization segment in the hybrid amorphous polyester resin can be identified by NMR measurement and methylation reaction Py-GC/MS measurement, for example.

A substituent such as a sulfonic acid group, a carboxy group, or a urethane group may be further introduced into the hybrid amorphous polyester resin. The substituent may be introduced into the amorphous polyester polymerization segment or into an amorphous vinyl polymerization segment to be detailed below.

(Amorphous Polymerization Segment)

In the present invention, an amorphous polymerization segment other than an amorphous polyester polymerization segment is also simply referred to as an “amorphous polymerization segment”. An amorphous polymerization segment (particularly an amorphous vinyl polymerization segment), when an amorphous vinyl resin is contained in the binding resin, enables the compatibility between the amorphous vinyl resin and the hybrid amorphous polyester resin to be controlled.

Incorporation of an amorphous polymerization segment in the hybrid amorphous polyester resin (further in the toner) can be confirmed by identification of the chemical structure using NMR measurement and methylation reaction Py-GC/MS measurement, for example.

The amorphous polymerization segment does not exhibit a melting point and has a relatively high glass transition temperature (Tg), when a resin having the same chemical structure and molecular weight as those of the amorphous polymerization segment is subjected to differential scanning calorimetry (DSC). The resin having the same chemical structure and molecular weight as those of the amorphous polymerization segment has a glass transition temperature (Tg) preferably within the range of 35 to 80° C. and more preferably within the range of 45 to 65° C.

It is preferred that some of the amorphous polyester polymerization segments be replaced by amorphous polymerization segments in the hybrid amorphous polyester resin described above and thus the polyester resin have a structure in which amorphous polyester polymerization segments and amorphous polymerization segments are bonded to each other. For example, a resin having a structure in which a main chain composed of a polymer including an amorphous polyester polymerization segment bonded with an amorphous polymerization segment is copolymerized with another component or a resin having a structure in which a polymer including an amorphous polyester polymerization segment bonded with an amorphous polymerization segment is copolymerized with a main chain including another component corresponds to a hybrid amorphous polyester resin having an amorphous polymerization segment in the present invention.

The amorphous polymerization segment is not particularly limited, and examples thereof include one obtained by polymerizing a vinyl compound, one obtained by polymerizing a polyol component and an isocyanate component, and one obtained by polymerizing urea and formaldehyde. Among these, an amorphous vinyl polymerization segment obtained by polymerizing a vinyl compound is preferred, and examples thereof include acrylic ester polymerization segments, styrene-acrylic ester polymerization segments, and ethylene-vinyl acetate polymerization segments. These may be used singly or in combination of two or more thereof.

In consideration of the thermoplasticity during thermofixing, among the vinyl polymerization segments described above, styrene-acrylic ester polymerization segments (styrene-acryl polymerization segments) are preferred. A preferred form of the amorphous vinyl resin is a styrene-acryl resin, and thus the amorphous vinyl polymerization segment is also preferably a styrene-acryl polymerization segment. When the segment has such a form, the compatibility of the hybrid amorphous polyester resin and the amorphous vinyl resin is further improved, and the shape of toner base particles is easily controlled.

The monomers and forming method for use in formation of the styrene-acryl polymerization segment are the same as the contents of the “Styrene-Acryl Polymerization Segment” sub-section described in the Hybrid Crystalline Polyester Resin section, and thus the description thereof is omitted.

The content of the amorphous polymerization segment in the hybrid amorphous polyester resin is preferably within the range of 0.1 to 50% by mass and more preferably within the range of 5 to 30% by mass based on the total mass of the hybrid amorphous polyester resin. When the content is within the range described above, the compatibility with the amorphous resin in the binding resin becomes higher, and low-temperature fixability, hot offset resistance, and heat resistance can be simultaneously achieved.

A method for producing a hybrid amorphous polyester resin is not particularly limited, as long as the method can form a polymer in which the amorphous polyester polymerization segment and amorphous polymerization segment described above are bonded to each other. Examples of a specific method for producing a hybrid amorphous polyester resin include the following methods.

(1) A method in which an amorphous polymerization segment is preliminarily polymerized, and a polymerization reaction to form an amorphous polyester polymerization segment is conducted in the presence of the amorphous polymerization segment to produce a hybrid amorphous polyester resin.

(2) A method in which an amorphous polyester polymerization segment and an amorphous polymerization segment each are formed in advance, and bonded with each other to produce a hybrid amorphous polyester resin.

(3) A method in which an amorphous polyester polymerization segment is preliminarily formed, and a polymerization reaction to form an amorphous polymerization segment is conducted in the presence of the amorphous polyester polymerization segment to produce a hybrid amorphous polyester resin.

Among the formation methods (1) to (3) described above, the method (1) is preferred from the viewpoints that a hybrid amorphous polyester resin having a structure in which an amorphous polyester polymerization segment is grafted to an amorphous polymerization segment is easily formed and that the production step can be simplified.

Further in the toner base particles, internal additives such as a colorant, a mold-releasing agent, and a charge controlling agent may be contained as required.

[1.3 Other Components]

The toner base particles according to the present invention may contain a mold-releasing agent (wax), a charge controlling agent, and the like as required, in addition to the binding resin and the colorant. Incorporation of a mold-releasing agent enables the mold-releasability of the toner from a fixing member and the like to be improved. Incorporation of a charge controlling agent enables the chargeability of the toner base particles to be adjusted.

[Mold-releasing Agent]

Examples of the mold-releasing agent include, but are not particularly limited to, hydrocarbon waxes including polyethylene wax, paraffin wax, microcrystalline wax, and Fischer-Tropsch wax; dialkyl ketone waxes including distearyl ketone; carnauba wax, montan wax; ester waxes including behenyl behenate, behenic acid behenate, trimethylolpropane tribehenate, pentaerythritol tetramyristate, pentaerythritol tetrastearate, pentaerythritol tetrabehenate, pentaerythritol diacetate dibehenate, glycerin tribehenate, 1,18-octadecane diol distearate, tristearyl trimellitate, and distearyl maleate; and amide waxes including ethylene diamine dibehenylamide and tristearylamide trimellitate. These may be used singly or in combination of two or more thereof.

The content of the mold-releasing agent is preferably within the range of 2 to 30% by mass and more preferably within the range of 5 to 20% by mass based on the total mass of the toner base particles. When the content of the mold-releasing agent is 2% by mass or more, the mold-releasability of the toner from a fixing member can be sufficiently obtained, and when the content of the mold-releasing agent is 30% by mass or less, a sufficient amount of the binding resin can be contained in the toner base particles, and fixability of an image can be sufficiently obtained.

[Charge Controlling Agent]

The charge controlling agent is not particularly limited, and examples thereof include nigrosine based dyes, metal salts of naphthenic acid or higher fatty acids, alkoxylated amines, quaternary ammonium salt compounds, azo metal complexes, and salicylic acid metal salts or metal complexes thereof.

From the viewpoint of the amount of charge, the content of the charge controlling agent is preferably within the range of 0.1 to 10% by mass and more preferably within the range of 0.5 to 5% by mass based on the total mass of the binding resin.

[1.4 Structure of Toner Base Particles]

The structure of the toner base particles according to the present invention may be a single layer structure only including the toner base particles mentioned above or may be a multilayer structure such as a core-shell structure including the toner base particles mentioned above as core particles and a shell layer with which the core particles and the surface thereof are coated. The shell layer may not be coated on the entire surface of the core particles, and the core particles may be partially exposed. A cross section of the core-shell structure can be observed with a known observation measure, such as a transmission electron microscope (TEM) and a scanning probe microscope (SPM).

In the case of the core-shell structure, the core particles may have properties, such as glass transition temperature, melting point, and hardness, different from those of the shell layer, and toner base particles may be designed in accordance with the purpose. For example, a resin having a relatively high glass transition temperature can be aggregated and fused on the surface of core particles containing a binding resin, a colorant, a mold-releasing agent, and the like and having a relatively low glass transition temperature to thereby form a shell layer.

In the toner of the present invention, it is preferred that the mold-releasing agent be not exposed on the toner particle surface and be present near the surface of the toner particles, from the viewpoint of reduction of fogging and the like. For example, in the case where the toner base particles contain a vinyl resin and the mold-releasing agent contains ester wax, the mold-releasing agent is present near the vinyl resin. Thus, the vinyl resin is preferably present also near the surface of the toner particles. In other words, it is preferred that the toner contain toner base particles having a laminate structure of at least two or more layers (inner layer and outer layer) and that the outer layer (surface layer) contain a vinyl resin and a mold-releasing agent containing ester wax. The outer layer may further contain an amorphous polyester resin as the main component. In order to further improve the effects of the present invention, domains of the vinyl resin described above are preferably dispersed in the matrix of the amorphous polyester resin.

The average circularity of the toner base particles is preferably within the range of 0.935 to 0.995, more preferably within the range of 0.945 to 0.990, and further preferably within the range of 0.955 to 0.980. When the average circularity is within the range described above, each of the toner particles is unlikely to be crushed, the amount of charge is stabilized, and a high quality image can be obtained. The average circularity can be measured using, for example, a flow-type particle image analyzer “FPIA-3000” (manufactured by Sysmex Corporation).

In a specific measurement method, the toner base particles are moistened with an aqueous solution of a surfactant and then dispersed by conducting ultrasonic dispersion for one minute. Thereafter, the dispersion was subjected to measurement using “FPIA-2100” in a measurement condition HPF (high-magnification photographing) mode at an appropriate density of the HPF detection number of 4000. The circularity is calculated by the following expression.

Circularity=(circumferential length of a circle having the same projected area as a particle image)/(circumferential length of a particle projected image)

The average circularity is an arithmetic average value obtained by summing circularity of each of the particles and dividing the resulting value by the total number of the particles.

[2 External Additive]

An “external additive” is added from the viewpoint of improving charging performance, fluidity, cleanability, and the like and adheres to the surface of the toner base particles.

[2.1 Titanium Oxide]

The toner according to the present invention contains titanium oxide as an external additive. Externally adding titanium oxide enables fluidity of the toner to be obtained. Titanium oxide is low resistant, and thus external addition thereof to the surface of the toner base particles allows the resistance of the toner to be lowered.

The content of titanium oxide is characterized by being within the range of 0.01% by mass or more and less than 1.00% by mass based on the total mass of the toner base particles. When the content of titanium oxide is less than 0.01% by mass, the fluidity of the toner cannot be sufficiently obtained. When the content of titanium oxide is 1.00% by mass or more, titanium oxide functions as a white pigment, and thus the black color developability (image density) of the toner decreases.

Titanium oxide is likely to be detached from the toner base particle surface because of its high density, but a content of titanium oxide of less than 1.00% by mass based on the total mass of the toner base particles enables decrease in the chargeability caused by migration of titanium oxide to the carrier to be reduced. Also in continuous printing at a high coverage, excellent charging stability can be obtained. Additionally, deterioration in cleanability due to excessive fluidity also can be reduced.

The shape and the like of titanium oxide is not particularly limited, and the number average particle diameter of titanium oxide is preferably within the range of 10 to 50 nm and more preferably within the range of 20 to 40 nm. When the number average particle diameter of titanium oxide is within the range described above, titanium oxide is more unlikely to be buried in the toner base particles. Simultaneously, it is considered that sufficient points of contact with the carrier are obtained and migration to the carrier is also reduced.

It is important for titanium oxide to present on the surface of the toner base particles and not to migrate to the carrier in order to maintain the chargeability of a developer. When the number average particle diameter of titanium oxide is 50 nm or less, in the case where particles having a large particle diameter are used in combination as an external additive, the particles having a large particle diameter serves as a spacer, and thus titanium oxide is more unlikely to be released from the toner base particles. Accordingly, excellent startability of charging in continuous printing and charging stability over a long period of use can be obtained.

The number average particle diameter of titanium oxide can be measured by the following method. A scanning electron microscope (SEM) is used to photograph a toner image at a magnification of 40000 times. Then, an SEM image in which titanium oxide is defined is subjected to binarization processing, and the particle diameter is measured. The number particle size distribution is determined based on the particle diameter and number of 100 primary particles measured.

The type of titanium oxide is particularly limited, and preferred is a hydrophobic titanium oxide subjected to a surface modifying treatment with a surface modifying treatment agent. Hydrophobic titanium oxide can lower the amount of moisture to be adsorbed and thus can reduce decrease in the amount of charge under a charging environment, for example, a high-temperature and high-humidity environment.

Examples of the surface modifying treatment agent that can be used include common silane coupling agents, silicone oils, fatty acid, and fatty acid metal salts.

Examples of silane coupling agents include chlorosilane, alkoxysilane, silazane, and special silylating agents. Specific example thereof include methyltrichlorosilane, dimethyldichlorosilane, trimethylchlorosilane, phenyltrichlorosilane, diphenyldichlorosilane, tetramethoxysilane, methyltrimethoxysilane, dimethyldimethoxysilane, phenyltrimethoxysilane, diphenyldimethoxysilane, tetraethoxysilane, methyltriethoxysilane, dimethyldiethoxysilane, phenyltriethoxysilane, diphenyldiethoxysilane, isobutyltrimethoxysilane, decyltrimethoxysilane, hexamethyldisilazane, N,O-(bistrimethylsilyl)acetamide, N,N-bis(trimethylsilyl)urea, tert-butyldimethylchlorosilane, vinyltrichlorosilane, vinyltrimethoxysilane, vinyltriethoxysilane, γ-methacryloxypropyltrimethoxysilane, β-(3,4-epoxycyclohexyl)ethyltrimethoxysilane, γ-glycidoxypropyltrimethoxysilane, γ-glycidoxypropylmethyldiethoxysilane, γ-mercaptopropyltrimethoxysilane, and γ-chloropropyltrimethoxysilane.

Specific examples of silicone oils include organosiloxane oligomers, cyclic compounds such as octamethylcyclotetrasiloxane, or decamethylcyclopentasiloxane, tetramethylcyclotetrasiloxane, and tetravinyl tetramethylcyclotetrasiloxane, and linear or branched organosiloxanes.

There may be used a highly reactive silicone oil having a modifying group introduced into a side chain, or one terminal or both terminals or one side-chain terminal or both side-chain terminals, the silicone oil having at least a terminal modified. Examples of types of the modifying group include, but are not limited to, alkoxy, carboxy, carbinol, higher fatty acid-modified, phenol, epoxy, methacrylic, and amino. The silicone oils may have several types of modifying groups, for example, amino-/alkoxy-modification. Alternatively, a dimethyl silicone oil and these modified silicone oils, and further other surface modifying treatment agents may be mixed or combined for treatment.

Examples of a surface modifying treatment method include dry methods such as a spray dry method in which a modifying treatment agent or a solution containing a modifying treatment agent is sprayed to particles suspended in the gas phase, a wet method in which particles are immersed in a solution containing a treatment agent and then dried, and a mixing method in which a treatment agent and particles are mixed by means of a mixer.

Examples of commercially available titanium oxide include “CR-50-2” and “CR-58” (both are brand names, manufactured by ISHIHARA SANGYO KAISHA, LTD.).

[2.2 Other External Additives]

The external additive according to the present invention may be used in combination with conventionally known external additives, in addition to titanium oxide.

Examples of conventionally known external additives include particles containing, as the main component, an inorganic material such as silica particles, alumina particles, zirconia particles, zinc oxide particles, chromium oxide particles, cerium oxide particles, antimony oxide particles, tungsten oxide particles, tin oxide particles, tellurium oxide particles, manganese oxide particles, boron oxide particles, or strontium titanate particles. Particles containing these inorganic materials as the main component may be hydrophobized with a surface modifying treatment agent such as a silane coupling agent, a silicone oil, or the like, as required. The particle diameter thereof is preferably within the range of 20 to 500 nm and more preferably within the range of 70 to 300 nm.

Also as conventionally known external additives, particles containing, as the main component, an organic material such as a homopolymer of styrene, methyl methacrylate, or the like or a polymer thereof may be contained The particle diameter thereof is preferably within the range of 10 to 1000 nm.

Further, a lubricant such as a metal salt of a higher fatty acid may be contained. Examples of higher fatty acids include stearic acid, oleic acid, palmitic acid, linoleic acid, and recinoleic acid. Examples of metal constituting metal salts include zinc, manganese, aluminum, iron, copper, magnesium, and calcium.

The content of these external additives, as the total content of the external additives and titanium oxide, is preferably within the range of 0.05 to 5.0% by mass based on the total mass of the toner base particles.

[3 Method for Producing Toner]

(Method for Producing Toner Base Particles)

Examples of a method for producing toner base particles include, but are not particularly limited to, known methods such as a kneading pulverization method, a suspension polymerization method, an emulsion aggregation method, a dissolution suspension method, a polyester stretching method, and a dispersion polymerization method.

Among these, an emulsion aggregation method is preferably employed from the viewpoint of uniformity of the particle diameter, controllability of the shape, and ease of formation of the core-shell structure. Hereinafter, an emulsion aggregation method will be described.

<Emulsion Aggregation Method>

An emulsion aggregation method is a method for forming toner particles in which a dispersion liquid of particles of a resin (hereinafter, also referred to as “resin particles”) dispersed with a surfactant or a dispersion stabilizer is mixed with a dispersion liquid of toner particle constituents such as colorant particles, a coagulant is added thereto to allow the toner particles to aggregate until a desired toner particle diameter is achieved, and the resin particles are fused thereafter or simultaneously with aggregation to control the shape of the toner particles.

The resin particles may be composite particles formed of a plurality of layers, which is configured by two or more layers each including a resin of a different composition.

The resin particles can be produced, by for example, an emulsion polymerization method, a miniemulsion polymerization method, a phase-transfer emulsification, or the like, or can be produced by a combination of several production methods. When internal additives are contained in the resin particles, in particular, a miniemulsion polymerization method is preferably used.

When internal additives are contained in the toner base particles, the internal additives may be contained in the resin particles. Alternatively, a dispersion liquid of internal additive particles containing only internal additives is separately prepared, and the internal additive particles may aggregate simultaneously when the resin particles aggregate.

The emulsion aggregation method also enables toner base particles having a core-shell structure to be obtained. Specifically, the toner base particles can be obtained by first allowing binding resin particles for core portions and a colorant to aggregate (to be fused) to produce particulate core portions, then adding binding resin particles for a shell layer to the dispersion liquid of the core portions, and allowing the binding resin particles for a shell layer to aggregate or and fused on the surface of each of the core portions to thereby form a shell layer with which the surface of each of the core portions is coated.

The binding resin according to the present invention preferably contains a crystalline resin and an amorphous resin.

When toner base particles are produced by the emulsion aggregation method, an embodiment preferably include a step of preparing, as a binding resin particle dispersion liquid, a crystalline resin particle dispersion liquid, an amorphous resin particle dispersion liquid, and a colorant dispersion liquid (hereinafter, also referred to as a preparation step) (1), and a step of mixing the crystalline resin particle dispersion liquid, amorphous resin particle dispersion liquid, and colorant dispersion liquid to aggregate/fuse the particles (hereinafter, also referred to as an aggregation/fusing step) (2).

Hereinafter, each of the steps each will be detailed.

(1) Preparation Step

Step (1) more specifically includes a crystalline resin particle dispersion liquid preparation step, an amorphous resin particle dispersion liquid preparation step, and a colorant dispersion liquid preparation step, and additionally includes a mold-releasing agent dispersion liquid preparation step and the like, as required.

(1-1) Crystalline Resin Particle Dispersion Liquid Preparation Step and Amorphous Resin Particle Dispersion Liquid Preparation Step

The crystalline resin particle dispersion liquid preparation step is a step of preparing a dispersion liquid of crystalline resin particles by synthesizing a crystalline resin constituting toner base particles and dispersing this crystalline resin into particles in an aqueous medium. The amorphous resin particle dispersion liquid preparation step is a step of preparing a dispersion liquid of an amorphous resin particles by synthesizing an amorphous resin constituting toner base particles and dispersing this amorphous resin into particles form in an aqueous medium.

Examples of methods for dispersing a crystalline resin in an aqueous medium include a method in which the crystalline resin is dissolved or dispersed in an organic solvent (solvent) to prepare an oil phase liquid, the oil phase liquid is dispersed in an aqueous medium by phase inversion emulsification or the like to form oil droplets of which the particle diameter is desirably controlled, and then the organic solvent is removed. The same applies to a method for dispersing an amorphous resin in an aqueous medium.

The organic solvent (solvent) for use in preparation of the oil phase liquid is preferably a solvents having a low boiling point as well as low solubility in water from the viewpoint of ease of a removal treatment after oil droplets are formed. Examples thereof include methyl acetate, ethyl acetate, methyl ethyl ketone, isopropyl alcohol, methyl isobutyl ketone, toluene, and xylene. These may be used singly or in combination of two or more thereof.

The amount of the organic solvent (solvent) to be used (total amount to be used when two or more solvents are used) is preferably within the range of 1 to 300% by mass, more preferably within the range of 10 to 200% by mass, and further preferably within the range of 25 to 100% by mass based on the total mass of the resin.

From the viewpoint of stable emulsification and smooth progress of emulsification, carboxy groups in the oil phase liquid have been preferably subjected to dissociation of the proton (H⁺) ion, and in order to facilitate dissociation, ammonia, sodium hydroxide, or the like is preferably added to the oil phase liquid.

The amount of the aqueous medium to be used is preferably within the range of 50 to 2,000% by mass and more preferably within the range of 100 to 1,000% by mass based on the total mass of the oil phase liquid. When the amount of the aqueous medium to be used is within the range described above, the oil phase liquid can be emulsified and dispersed at a desired particle diameter in the aqueous medium.

A dispersion stabilizer may be dissolved in the aqueous medium, and for the purpose of improving the dispersion stability of oil droplets, a surfactant and resin particles may be added to the aqueous medium.

Examples of the dispersion stabilizer can include inorganic compounds such as calcium triphosphate, calcium carbonate, titanium oxide, colloidal silicas, and hydroxyapatite. From the viewpoint of removal of the dispersion stabilizer from toner base particles to be obtained, ones soluble in acid and alkali such as calcium triphosphate are preferably used, and from the viewpoint of environmental aspect, ones degradable by an enzyme are preferably used.

Examples of surfactants include anionic surfactants such as alkylbenzene sulfonates, α-olefin sulfonates, phosphate esters, sodium alkyl diphenyl ether disulfonate, and sodium polyoxyethylene lauryl ether sulfate; cationic surfactants including amine salt-types such as alkylamine salts, amino alcohol fatty acid derivatives, polyamine fatty acid derivatives, and imidazoline, and quaternary ammonium salt-types such as alkyl trimethyl ammonium salts, dialkyl dimethyl ammonium salts, alkyl dimethyl benzyl ammonium salts, pyridinium salts, alkylisoquinolinium salts, and benzethonium chloride; nonionic surfactants such as fatty acid amide derivatives and polyhydric alcohol derivative; and amphoteric surfactants such as alanine, dodecyl di(aminoethyl)glycine, di(octylaminoethyl)glycine, and N-alkyl-N,N-dimethyl ammonium betaine. Anionic surfactants and cationic surfactants having a fluoroalkyl group also can be used.

From the viewpoint of dispersion stability, the resin particles preferably have a particle diameter within the range of 0.5 to 3 μm. Specific examples thereof include polymethyl methacrylate resin particles having a particle diameter of 1 μm and 3 μm, polystyrene resin particles having a particle diameter of 0.5 μm and 2 μm, and polystyrene-acrylonitrile resin particles having a particle diameter of 1 μm.

Emulsifying dispersion of such oil phase liquids can be conducted using mechanical energy. A disperser for conducting emulsifying dispersion is not particularly limited, and examples thereof include a low speed shearing-type disperser, a high speed shearing-type disperser, a friction-type disperser, a high pressure jet-type disperser, an ultrasonic disperser such as an ultrasonic homogenizer, and a high pressure impulse-type disperser ultimaizer

Removal of the organic solvent after oil droplets are formed may be conducted by an operation in which a whole dispersion liquid including crystalline resin particles dispersed in an aqueous medium is subjected to gradual temperature increase under stirring, vigorous stirring is given to the dispersion in a predetermined temperature range, and then, the solvent is removed, or the like. Alternatively, the organic solvent can be removed while the pressure is reduced using an apparatus such as an evaporator. The organic solvent can be removed also from amorphous resin particulates after oil droplets are formed in the same manner as for the crystalline resin particles described above.

Crystalline resin particles (oil droplets) in a crystalline resin particle dispersion liquid or amorphous resin particles (oil droplets) in an amorphous resin particle dispersion liquid to be thus obtained have an average particle diameter preferably within the range of 60 to 1000 nm and more preferably within the range of 80 to 500 nm. The average particle diameter of the resin particles, colorant particles, mold-releasing agent, and the like can be measured with a laser diffraction/scattering particle size distribution analyzer (microtrac particle size distribution analyzer “UPA-150” (manufactured by NIKKISO CO., LTD.)). The average particle diameter of these resin particles (oil droplets) can be controlled by means of the magnitude of the mechanical energy during emulsifying dispersion.

The content of the crystalline resin particles in a crystalline resin particle dispersion liquid or the amorphous resin particles in an amorphous resin particle dispersion liquid is preferably within the range of 10 to 50% by mass and more preferably within the range of 15 to 40% by mass based on the total mass of the dispersion liquid. When the content is within the range described above, the spread of the particle size distribution is reduced, and the toner characteristics can be improved.

(1-2) Colorant Particle Dispersion Liquid Preparation Step

The colorant particle dispersion liquid preparation step is a step of preparing a dispersion liquid of pigment particles by dispersing a colorant (including a pigment in the present invention) into a particle form in an aqueous medium.

The aqueous medium is as described in (1-1) above, and the surfactants listed in (1-1) above, resin particles, or the like may be added in this aqueous medium for the purpose of improving the dispersion stability.

The pigment can be dispersed using mechanical energy. Such a disperser is not particularly limited, and examples thereof include, as listed above, a low speed shearing-type disperser, a high speed shearing-type disperser, a friction-type disperser, a high pressure jet-type disperser, an ultrasonic disperser such as an ultrasonic homogenizer, or a high pressure impulse-type disperser ultimaizer.

From the viewpoint of dispersibility, the total content of the pigment particles in the pigment particle dispersion liquid is preferably within the range of 5 to 40% by mass and more preferably within the range of 10 to 30% by mass based on the total mass of the dispersion liquid.

(1-3) Mold-releasing Agent Particle Dispersion Liquid Preparation Step

This mold-releasing agent particle dispersion liquid preparation step, which is a step to be conducted as required when toner base particles are desired to contain a mold-releasing agent, is a step of preparing a dispersion liquid of mold-releasing agent particles by dispersing a mold-releasing agent into a particle form in an aqueous medium.

The aqueous medium is as described in (1-1) above, and the surfactants listed in (1-1) above or resin particles may be added in this aqueous medium from the viewpoint of dispersion stability.

The mold-releasing agent can be dispersed using mechanical energy. Such a disperser is not particularly limited, and examples thereof include, as listed above, a low speed shearing-type disperser, a high speed shearing-type disperser, a friction-type disperser, a high pressure jet-type disperser, an ultrasonic disperser such as an ultrasonic homogenizer, a high pressure impulse-type disperser ultimaizer, or a high pressure homogenizer. On dispersing the mold-releasing agent particles, heating may be conducted as required.

The content of the mold-releasing agent particles in the mold-releasing agent particle dispersion liquid is preferably within the range of 10 to 50% by mass and more preferably within the range of 15 to 40% by mass based on the total mass of the dispersion liquid. When the content is within the range described above, an effect of hot offset resistance and ensuring separability can be obtained.

(2) Aggregation/Fusion Step

The crystalline resin particle dispersion liquid, amorphous resin particle dispersion liquid, and pigment particle dispersion liquid, and other components such as a mold-releasing agent particle dispersion liquid as required are added and mixed. Subsequently, slow aggregation is attained while the repulsive force of the particle surface due to pH adjustment and the coagulation force due to the coagulant including an electrolyte body are balanced. Association is conducted while the average particle diameter and the particle size distribution are controlled, and simultaneously, the shape is controlled by fusing particulates under stirring with heating to thereby form toner particles. This aggregation/fusion step can be conducted also by use of mechanical energy or a heating measure as required.

In the aggregation step, first, each of the dispersion liquids obtained are mixed into a mixed liquid. The mixed liquid is allowed to aggregate by heating at a temperature equal to or lower than the glass transition temperature of the amorphous resin to form aggregated particles. The aggregated particles are formed under stirring by making the pH of the mixed liquid acidic. The pH is preferably within the range of 2 to 7, more preferably within the range of 2 to 6, and further preferably within the range of 2 to 5.

Also in the aggregation step, a coagulant is preferably used. The coagulant is not particularly limited. In addition to a surfactant having a polarity opposite to that of the surfactant used as a dispersing agent and inorganic metal salts, a complex containing a divalent or more metal is suitably used.

Examples of inorganic metal salts include metal salts such as sodium chloride, potassium chloride, lithium chloride, calcium chloride, barium chloride, magnesium chloride, zinc chloride, aluminum chloride, copper sulfate, magnesium sulfate, aluminum sulfate, manganese sulfate, and calcium nitrate; and inorganic metal salt polymers such as poly aluminum chloride, poly aluminum hydroxide, polysilicate iron, and calcium polysulfide. Among these, aluminum salts and poly aluminum chloride are particularly preferred. In order to obtain a sharper particle size distribution, the valence of the inorganic metal salt is more preferably divalent than monovalent, trivalent than divalent, and tetravalent than trivalent.

The content of the divalent or more metal ions in the toner base particles can be controlled by principally adjusting the pH, type, and the like of the mixed liquid in the present step.

A toner having a configuration in which the surface of core aggregated particles is coated with a crystalline resin and/or an amorphous resin (particles having a core-shell structure) can be produced by additionally adding crystalline resin particles and/or amorphous resin particles when the aggregated particles have reached a desired particle diameter. In the case of additional addition, an operation such as addition of a coagulant before the additional addition or adjustment of the pH may be conducted.

Heating and temperature increase are preferably conducted during the aggregation. In this case, if the fusing temperature is reached or exceeded by heating or temperature increase, the fusing step proceeds simultaneously. The temperature increase is preferably conducted at a temperature increase rate within the range of 0.1 to 5° C./min. The heating is preferably at a heating temperature (peak temperature) within the range of 40 to 100° C.

The average particle diameter of the aggregated particles is not particularly limited and is preferably within the range of 4.5 to 7 μm. When the aggregated particles have reached a desired particle diameter, an aggregation stopping agent is added for reducing the aggregation action of various particles in the reaction system to thereby stop the aggregation (hereinafter, also referred to as the aggregation stopping step), and thus the particle diameter can be controlled. An aggregation stopping agent refers to a basic compound that can adjust the pH in the direction away from a pH environment facilitating aggregation action. In the aggregation stopping step, the pH in the reaction system is preferably adjusted to 5 to 9.

Examples of the aggregation stopping agent (basic compound) include ethylenediaminetetraacetic acid (EDTA) and alkali metal salts such as sodium salt thereof, gluconal, sodium gluconate, potassium citrate and sodium citrate, nitrotriacetate (NTA) salt, GLDA (commercially available L-glutamic acid-N,N-diacetic acid), humic and fulvic acids, maltol and ethyl maltol, pentaacetic acid and tetraacetic acid, known compounds having both carboxy and hydroxy functional groups such as 3-hydroxy-2,2′-iminodisuccinic acid tetrasodium and salts thereof or water-soluble polymers (polymer electrolytes), sodium hydroxide, and potassium hydroxide. In the aggregation stopping step, stirring may be conducted in accordance with the aggregation step.

The fusion step is a step in which, after subjection to the aggregation stopping step described above or simultaneously with the aggregation step, the aggregated particles are coalesced by fusing each of the particles constituting aggregated particles with the reaction system warmed to a predetermined fusion temperature, and thereby coalesced particles are formed.

The fusion temperature in the fusion step is preferably equal to or higher than the melting point of the crystalline resin, and the fusion temperature is preferably higher by 0 to 20° C. than the melting point of the crystalline resin. Heating is only required to be conducted for a time period sufficient to achieve the fusion, and to be conducted for about 0.5 to 10 hours.

In the aggregation/fusion step, a surfactant having the same meaning as the surfactant used in (1-1) Crystalline Resin Particle Dispersion Liquid Preparation Step/Amorphous Resin Particle Dispersion Liquid Preparation Step and the like may be added to the aqueous medium, in order to stably disperse each of the particles in the system.

The ratio of the amorphous resin particles/crystalline resin particles to be added (mass ratio) in the aggregation/fusion step is preferably from 1 to 100. When the ratio is within the range described above, hot offset resistance and low-temperature fixability are excellent.

In the case of introduction of a different internal additive into the toner base particles, preferred is a method in which an internal additive particle dispersion liquid containing only the internal additive is prepared, and the internal additive particle dispersion liquid is mixed together with the crystalline resin particle dispersion liquid, amorphous resin particle dispersion liquid, and pigment dispersion liquid in the aggregation/fusion step.

The mixture is cooled after fusion to thereby obtain coalesced particles. The cooling rate is preferably from 1 to 20° C./min.

In the case of obtaining a toner by an emulsion aggregation method, the method preferably includes, after the aggregation/fusion step described above, a circularity control step (3) of controlling the circularity of the toner.

(3) Circularity Control Step

Specific examples of a circularity control treatment include a heat treatment that heats particles obtained in the aggregation/fusion step. The circularity can be controlled by adjusting the heating temperature and the retention time. The circularity can be brought closer to 1 by enhancing the heating temperature and extending the retention time.

The heating temperature in the circularity control treatment is preferably within the range of 70 to 95° C. The circularity can be controlled by measuring the circularity of particles having a particle diameter of 2 μm or more with a circularity measurement apparatus during warming and appropriately determining whether the circularity is desirable or not.

(4) Filtration/Washing Step

The dispersion liquid of the toner base particles obtained is cooled, and there are conducted a filtration treatment in which the toner base particles are solid-liquid separated from the dispersion liquid using a solvent such as water to filter the toner base particles off, and a washing treatment in which deposits such as the surfactant are removed from the toner base particles (an assembly in a cake form) filtered off.

The solid-liquid separation and washing method is not particularly limited, and specific examples of thereof include a centrifugation method, a filtration method under reduced pressure using an aspirator, a nutsche or the like, and a filtration method using a filter press. In the filtration/washing step, as appropriate, pH adjustment or pulverization may be conducted once or repeated.

(5) Drying Step

The toner base particles subjected to the washing treatment are dried. A dryer used in the drying step is not particularly limited, and examples thereof include an oven, a spray dryer, a vacuum freeze dryer, a reduced pressure dryer, a stationary rack dryer, a movable rack dryer, a fluidized bed dryer, a rotary dryer, and a stirring dryer. The moisture content in the dry-treated toner base particles to be measured by a Karl-Fisher coulometric titration method is preferably 5% by mass or less and more preferably 2% by mass or less.

In the case where the dry-treated toner base particles have aggregated with weak interparticle attraction to form aggregates, the aggregates may be subjected to be a crushing treatment. A crushing treatment apparatus is not particularly limited, and examples thereof include mechanical crushers such as a jet mill, a Comil, a Henschel mixer, a coffee mill, and a food processor.

(External Additive Addition Step)

The toner according to the present invention can be obtained by adding an external additive to the toner base particles obtained by the production method described above to attach the additive to the toner base particle surface.

A mixing apparatus for mixing the dry-treated toner base particles and external additive is not particularly limited, and examples thereof include known mixing apparatuses such as a Turbula mixer, a Henschel mixer, a Nauta mixer, a v-type mixer, and a sample mill. Sieve classification may be conducted as required in order to bring the particle size distribution of the toner within an appropriate range.

<Carrier>

The carrier according to the present invention includes a core material (hereinafter, also referred to as the “core material particles”) and a resin with which the surface of the core material is coated. The “coating” also includes a state in which the core material is partially coated with the resin. A layer composed of the coating resin is referred to as a “resin layer”, and a resin for use in coating is also referred to as a “resin for coating”.

When the core material particles are coated with a resin, the toner does not scatter, and thus a stable image density can be obtained. However, the core material particles including a material having magnetic properties are not exposed if completely coated with a resin, and thus the resistance of the carrier becomes higher. Thus, the carrier has to be coated with a resin such that the core material particles are moderately exposed.

Similarly in the case in which the material of the core material particles is one other than iron oxide-based materials, it is considered that setting the contents of elements shown below within the specific range in the predominant elements contained in the material of the core material particles causes the core material particles to be moderately exposed on the surface of the carrier and the similar effect can be obtained.

The expression (2) shown below represents the proportion of iron (also referred to as the “iron element content” or “ratio of amount of iron”) among the predominant elements (carbon, oxygen, and iron) on the carrier surface. Setting this proportion within a specific range causes the core material particles to be moderately exposed on the surface of the carrier.

Expression (2): Iron element content (atomic %)=A_{Fe}/(A_{C}+A_{O}+A_{Fe})

wherein A_{Fe}, A_{C}, and A_{O} represent respectively the contents of Fe, C, and O (atomic %) per unit area of the carrier surface.

In present invention, as indicated by the expression (1) described above, the iron element content represented by the expression (2) is characterized by being within the range of 2 to 20 atomic %. When the iron element content is less than 2 atomic %, the core material is insufficiently exposed, and thus the resistance of the carrier becomes higher. If the carrier is used as a developer in combination with the toner according to the present invention, the amount of charge is likely to decrease over a long period of use. When the content is more than 20 atomic %, the coating of the resin is insufficient, and the resistance of the carrier becomes very weak. Thus, when the carrier is used as a developer, the toner scatters, and a stable image density cannot be obtained.

The iron element content represented by the expression (2) can be measured by the following method. In surface element composition analysis by means of X-ray photoelectron spectroscopy (XPS measurement), a C1s spectrum for carbon, a Fe2p_{3/2} spectrum for iron, and an O1s spectrum for oxygen are measured. The contents of Fe, C, and O (atomic %) in a unit area of the carrier surface, denote by “A_{C}”, “A_{O}” and “A_{Fe}”, respectively, are determined on the basis of the spectrum of each of these elements, and the iron element content is calculated by the expression (2).

K-Alpha manufactured by Thermo Fisher Scientific K.K. was used as the XPS measurement apparatus, and the measurement was conducted using an Al monochlomatic X-ray as the X-ray source with the acceleration voltage set at 7 kV and the emission current set at 6 mV.

For the XPS measurement, after a sample is introduced in the measuring chamber and the degree of vacuum of the measuring chamber reaches 9.0×10⁻⁸ mbar, the X-ray is launched and the measurement is conducted.

Spot diameter: 400 μm

Number of Scans: 15

PASS Energy: 50 eV

Analysis method: Smart method

The volume average particle diameter of the carrier is preferably within the range of 15 to 28 μm and more preferably within the range of 20 to 25 μm. The volume average particle diameter of the carrier can be measured by the following method.

The volume average particle diameter of the carrier can be measured by a wet method using a laser diffraction-type particle size distribution analyzer “HEROS KA” (manufactured by Japan Laser Corporation). Specifically, first, an optical system at a focus position of 200 mm is selected, and the measurement time is set to 5 seconds. Specimen particles for measurement are then added to a 0.2% by mass sodium dodecyl sulfate aqueous solution and dispersed using an ultrasonic washer “US-1” (manufactured by AS ONE CORPORATION) for 3 minutes to produce a specimen dispersion liquid for measurement, several droplets of the specimen dispersion liquid are fed to “HEROS KA”, and measurement is started at a time when the specimen concentration gauge reaches a measurable range. The resulting particle size distribution was used to create the cumulative distribution from the smaller size with respect to the particle size range (channel), and the particle size at an accumulation of 50% was defined as the volume average particle diameter (D50).

Hereinafter, core material particles and a resin for coating constituting the carrier will be described.

[1 Core Material Particles]

In the present invention, an iron oxide-based material (ferrite) is used for the core material particles.

For the core material particles, besides iron oxide, a magnetic metal such as copper, nickel, or cobalt or a magnetic metal oxide is generally used. It is considered that causing the core material particles to be moderately exposed on the surface of the carrier enables the same effects as that of the present invention to be obtained also with these materials.

Ferrite is a compound represented by the general formula: (MO)ₓ(Fe₂O₃)_{y}, and the molar ratio y of Fe₂O₃ constituting ferrite is preferably within the range of 30 to 95 mol %. When the molar ratio y is within the range described above, ferrite is likely to be desirably magnetized, and carrier particles are unlikely to adhere to one another.

M in the general formula is a metal atom, and examples of M include manganese (Mn), magnesium (Mg), strontium (Sr), calcium (Ca), titanium (Ti), copper (Cu), zinc (Zn), nickel (Ni), aluminum (Al), silicon (Si), zirconium (Zr), bismuth (Bi), cobalt (Co), and lithium (Li). These metal atoms may be used singly or in combination of two or more thereof. Among these, manganese, magnesium, strontium, lithium, copper, and zinc are preferable, and manganese, magnesium, and strontium are more preferable, from the viewpoint that the residual magnetization is low and favorable magnetic characteristics can be obtained.

That is, the core material particles according to the present invention are preferably a ferrite containing at least one of manganese or magnesium and more preferably a ferrite containing both manganese and magnesium. In the ferrite containing both manganese and magnesium, from the viewpoint of ease of controlling the average magnetization within a desired range, the content of MnO is preferably within the range of 20 to 40 mol % and more preferably within the range of 7 to 30 mol % based on the total number of moles of the ferrite.

A commercially available product or a synthesized product may be used as the core material particles.

The volume average particle diameter of the core material particles is preferably within the range of 10 to 50 μm and more preferably within the range of 20 to 40 μm from the viewpoint of friction charging performance with a toner. The volume average particle diameter can be measured by the method mentioned above.

The shape of the surface of the core material particles is not particularly limited and preferably has irregularities moderately from the viewpoint of causing the core material to be exposed on the carrier surface. The degree of irregularities of the surface of the core material particles can be determined with a shape factor (SF-1).

The shape factor (SF-1) is a value calculated by the following expression. The case of a shape factor of 100 means that the shape of the particles is perfectly spherical, and a larger value means that the surface of the particles has large irregularities.

SF-1=(maximum length of carrier core material particle)²/(projected area of carrier core material particle)×(π/4)×100

A desired value can be obtained as the shape factor in the core material particles by appropriately selecting the firing temperature, materials (particularly, the type and formulation composition of the metal atoms represented by M mentioned above), and the like. The firing temperature is preferably within the range of 1000 to 2000° C. and more preferably within the range of 1000 to 1500° C. The shape factor in the core material particles is preferably within the range of 110 to 150 and more preferably within the range of 120 to 140. When the shape factor is within the range described above, the surface of the core material particles has irregularities moderately, and thus the iron element content expressed by the expression (2) can be adjusted within the range described above in a carrier coated with a resin. The irregularities of the core material particles become larger by making the shape factor larger. Thus, the core material particles are more likely to be exposed, and the iron element content expressed by the expression (2) also becomes larger.

The shape factor of the core material particles was measured by the following method. Micrographs of 100 or more particles of the carrier core material were randomly photographed at magnification of 150 times with a scanning electron microscope, and micrograph images captured with a scanner were used to measure the maximum length and projected area of the core material particles with an image processing analyzer LUZEX AP (manufactured by NIRECO CORPORATION). The “maximum length” is referred to as the maximum value among the lengths across in the image of each of the particles. A value calculated from the average value of the shape factors SF-1 calculated by the expression described above in the 100 core material particles was taken as the shape factor.

[2 Resin for Coating]

As the structural unit contained in the resin for coating, a structural unit derived from an alicyclic (meth)acrylic ester is preferably contained. Incorporation of a structural unit derived from an alicyclic (meth)acrylic ester compound allows the hydrophobicity of the resin to increase, and thus amount of moisture to be adsorbed onto the carrier is reduced. For this reason, the difference in chargeability of the carrier resulted from environmental differences can be made smaller, and particularly, decrease in the amount of charge under a high-temperature and high-humidity environment can be reduced. A resin containing a structural unit derived from an alicyclic (meth)acrylic ester compound has moderate mechanical strength, and in addition, has an advantage in that a new resin layer is exposed on the carrier surface as a result of moderate abrasion of the resin as the coating material and thus the carrier is refreshed.

Examples of alicyclic (meth)acrylic esters include cyclopropyl (meth)acrylate, cyclobutyl (meth)acrylate, cyclopentyl (meth)acrylate, cyclohexyl (meth)acrylate, cycloheptyl (meth)acrylate, dicyclopentanyl (meth)acrylate, cyclododecyl (meth)acrylate, methylcyclohexyl (meth)acrylate, trimethylcyclohexyl (meth)acrylate, t-butylcyclohexyl (meth)acrylate, and adamantyl (meth)acrylate. Among these, the alicyclic (meth)acrylic ester is preferably a (meth)acrylic ester having a cycloalkyl ring having 3 to 8 carbon atoms, more preferably cyclohexyl (meth)acrylate or cyclopentyl (meth)acrylate, because the effects described above are more likely obtained. From the viewpoint of mechanical strength and environmental stability of the amount of charge, cyclohexyl methacrylate is further preferable. Alicyclic (meth)acrylic esters may be used singly or in combination of two or more thereof.

As a polymerization component, besides alicyclic (meth)acrylic esters, other monomers that can be copolymerized with the alicyclic (meth)acrylic ester may be used. Examples of other monomers include styrene compounds such as styrene, o-methylstyrene, m-methylstyrene, p-methylstyrene, α-methylstyrene, p-chlorostyrene, 3,4-dichlorostyrene, p-phenylstyrene, p-ethylstyrene, 2,4-dimethylstyrene, p-tert-butylstyrene, pn-hexylstyrene, p-n-octylstyrene, p-n-nonylstyrene, p-n-decylstyrene, and p-n-dodecylstyrene; methacrylic ester compounds such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, benzyl methacrylate, isobornyl methacrylate, diethylaminoethyl methacrylate, and dimethylaminoethyl methacrylate; acrylic ester compounds such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, phenyl acrylate, and benzyl acrylate; olefin compounds such as ethylene, propylene, and isobutylene; halogenated vinyl compounds such as vinyl chloride, vinylidene chloride, vinyl bromide, vinyl fluoride, and vinylidene fluoride; vinyl ester compounds such as vinyl propionate, vinyl acetate, and vinyl benzoate; vinyl ether compounds such as vinylmethylether and vinylethylether; vinyl ketone compounds such as vinyl methyl ketone, vinyl ethyl ketone, and vinyl hexyl ketone; N-vinyl compounds such as N-vinylcarbazole, N-vinylindole, and N-vinylpyrrolidone; vinyl compounds such as vinylnaphthalene and vinylpyridine; and acrylic acid or methacrylic acid derivatives such as acrylonitrile, methacrylonitrile, and acrylamide. These other monomers may be used singly or in combination of two or more thereof.

From the viewpoint of mechanical strength and environmental stability of the amount of charge, among these, a chain-type (meth)acrylic ester such as methyl (meth)acrylate, ethyl (meth)acrylate, propyl (meth)acrylate, n-butyl (meth)acrylate, hexyl (meth)acrylate, octyl (meth)acrylate, and 2-ethylhexyl (meth)acrylate or styrene is preferably used, and a chain-type (meth)acrylic ester is more preferably used. The alkyl group of a chain-type (meth)acrylic ester preferably has 1 to 8 carbon atoms. A copolymer of an alicyclic (meth)acrylic ester and a chain-type (meth)acrylic ester is preferable because the carrier is likely to be refreshed and the stress resistance in a developing device is excellent.

The mass ratio of an alicyclic (meth)acrylic ester and a chain-type (meth)acrylic ester to be contained is not particularly and is preferably alicyclic (meth)acrylic ester:chain-type (meth)acrylic ester=10:90 to 90:10 (mass ratio) and more preferably from 30:70 to 70:30.

A method for producing a resin for coating is not particularly limited, and conventionally known polymerization methods are utilized as appropriate. Examples thereof include a pulverization method, an emulsifying dispersion method, a suspension polymerization method, a solution polymerization method, a dispersion polymerization method, an emulsion polymerization method, an emulsion polymerization aggregation method, and other known methods. Particularly, from the viewpoint of control of the particle diameter, synthesis by an emulsion polymerization method is preferable.

The polymerization initiator and the surfactant to be used in the emulsion polymerization method, in addition to the monomer described above, and further a chain transfer agent to be additionally used if necessary, and the polymerization conditions such as the polymerization temperature are not particularly limited. Polymerization initiators, surfactants, chain transfer agents, and the like conventionally known can be used, and the polymerization conditions such as the polymerization temperature also can be adjusted by use of conventionally known polymerization conditions as appropriate.

The weight average molecular weight of the resin for coating (polymer obtained by polymerizing the monomer described above) is not particularly limited, and is preferably within the range of 200000 to 800000 and more preferably within the range of 300000 to 700000. When the weight average molecular weight of the resin for coating is 200000 or more, attrition of the resin layer formed on the surface of the core material particles is not excessively facilitated and the carriers are unlikely to adhere to one another. When the weight average molecular weight of the resin for coating is 800000 or less, decrease in the amount of charge due to migration of the external additive from the toner particles to the carrier surface is unlikely to occur, and decrease in the amount of charge over a long period of use can be reduced.

As a method for measuring the weight average molecular weight of the resin for coating, the measurement method by use of gel permeation chromatography (GPC) mentioned above can be used.

[3 Method for Producing Carrier]

(Method for Producing Core Material Particles)

The core material particles of the carrier according to the present invention can be produced by the following method, for example. Raw materials in an appropriate amount are weighed, and then pulverized and mixed with a ball mill, a vibration mill, or the like for 0.5 hours or more and preferably for 1 to 20 hours. The pulverized product thus obtained is pelletized using a pressure molding apparatus or the like and then calcined at 700 to 1200° C.

The raw materials may be pulverized, then slurried by addition of water, and granulated using a spray dryer without use of a pressure molding apparatus. After calcined, the calcined product is further pulverized with a ball mill, a vibration mill, or the like. Then, water and, as required, a dispersing agent, a binder, and the like are added thereto, the viscosity is adjusted, and the mixture is granulated. Firing is conducted while the oxygen concentration is controlled and the granulated product is maintained at 1300 to 1500° C. for 1 to 24 hours (the temperature setting is higher than before in order to set the carrier core material shape factor (SF-1) within the range of 110 to 150). For pulverization after the calcination, the calcined product, with water added thereto, may be pulverized with a wet ball mill, a wet vibration mill, or the like.

The pulverizer such as the ball mill, vibration mill, or the like described above is not particularly limited, and particulate beads having a particle diameter of 1 mm or less are preferably used as the medium to be used, in order to effectively and uniformly disperse the raw materials. The degree of pulverization can be controlled by adjusting the diameter and composition of beads to be used and the pulverization time.

The fired product thus obtained is pulverized and classified. The particle size is adjusted to a desired particle diameter using an existing air classification, a mesh filtration method, a precipitation method, or the like as the classification method.

Thereafter, the electrical resistance can be adjusted by heating the surface at a low temperature to conduct an oxide film treatment, as required. As the oxide film treatment, a heat treatment can be conducted using a common rotary electric furnace, a batch-type electric furnace, or the like, for example, at from 300 to 700° C. The thickness of the oxide film formed in this treatment is preferably within the range of 0.1 nm to 5 μm. When the thickness is 0.1 nm or more, the effect of the oxide film layer can be sufficiently obtained, and when the thickness is 5 μm or less, desired magnetization and resistance can be obtained. Reduction may be conducted before the oxide film treatment as required. The residual magnetization of the core material particles is preferably 15 emu/g (Am²/kg) or less.

(Method for Forming Resin Layer) The carrier according to the present invention can be obtained by forming a resin layer on the core material particles.

Specific examples of methods for forming a resin layer that can be used include known methods such as a wet coating method and a dry coating method. Each of the methods will be described below. The dry coating method is a particularly desirable method to be applied to the present invention and will be described more in detail. However, the coating method is not limited to the following methods.

The wet coating method includes the following methods.

(1) Fluidized Bed Spray Coating Method

For example, a method in which a coating liquid prepared by dissolving the resin for coating is applied by spray-coating on the surface of the core material particles using a fluidized bed, and the liquid is then dried to form a resin layer.

(2) Immersion Coating Method

A method in which the core material particles are subjected to a coating treatment by immersion in a coating liquid prepared by dissolving the resin for coating in a solvent, and the liquid is then dried to form a resin layer.

(3) Polymerization Method

A method in which the core material particles are subjected to a coating treatment by immersion in a coating liquid prepared by dissolving a reactive compound in a solvent, and a polymerization reaction is then conducted by applying heat or the like to form a resin layer.

(4) Dry Coating Method

A method in which the resin particles for coating are caused to adhere to the surface of core material particles to be coated, and thereafter, the resin particles adhering to the surface of the carrier described above are melted or softened by application of a mechanical impact force so as to be immobilized to the surface, and thereby a resin layer is formed.

Specifically, a mixture of carrier core material particles, resin particles, low-resistant particulates, and the like is stirred at a high speed with or without heating using a high-speed stirring mixer that can give a mechanical impact force. Thus, an impact force is repeatedly given to the mixture described above to cause the resin particles and the like to be dissolved or softened and then immobilized on the surface of the core material particles, and thereby a carrier having a resin layer is formed.

As for dry coating conditions, in the case of heating, the temperature is preferably from 80 to 130° C., and the wind speed for generating an impact force is preferably 10 m/s or more during heating, and preferably 5 m/s or less during cooling in order to reduce aggregation of carriers. The time period for giving the impact force is preferably from 20 to 60 minutes.

<Two-Component Developer>

The two-component developer of the present invention contains an electrostatic image developing toner and a carrier. The ratio of the toner based on the sum of the total masses of the toner and the carrier is not particularly limited, and is preferably within the range of 8 to 10% by mass from the viewpoint of chargeability of the toner and high image quality after continuous printing.

The two-component developer can be produced by mixing the toner and the carrier using a mixing apparatus. Examples of the mixing apparatus include a Henschel mixer, a Nauta mixer, and a v-type mixer.

<<Image Forming Apparatus>>

An image forming apparatus in which the two-component developer of the present invention is suitably used will be described. The image forming apparatus may be a 4-cycle type image forming apparatus composed of color developing devices of four colors: yellow, magenta, cyan, and black, and one electrophotographic photoreceptor, or may be a tandem type image forming apparatus composed of color developing devices of four colors: yellow, magenta, cyan, and black, and four electrophotographic photoreceptors provided for each of the colors, for example.

The figure shows a schematic configuration view illustrating an exemplary image forming apparatus 100 related to the present embodiment. The image forming apparatus 100 shown in the figure has an image reading section 110, an image processing section 30, an image forming section 40, a sheet transport section 50, and a fixing device 60.

The image forming section 40 has image forming units 41Y, 41M, 41C, and 41K that form images with toners of the respective colors: Y (yellow), M (magenta), C (cyan), and K (black). These units have the same configuration except for the toner to be accommodated, so the symbol indicating the color may be omitted hereinafter. The image forming section 40 has an intermediate transfer unit 42 and a secondary transfer unit 43. These are equivalent to a transfer device.

In present embodiment, the toner according to the present invention is used as the K toner. As the K developer, the two-component developer of the present invention is used.

The image forming unit 41 has an exposure device 411, a developing device 412, an electrophotographic photoreceptor (image support) 413, a charging device 414, and a drum cleaning device 415. The charging device 414 is a corona charger, for example. The charging device 414 may also be a contact charging device that brings a contact charging member, such as a charged roller, a charged brush, or a charged blade, into contact with the electrophotographic photoreceptor 413 thereby to charge the same. The exposure device 411 includes, for example, a semiconductor laser as a light source and a light deflector (polygon motor) that applies a laser beam correspondingly to an image to be formed toward the electrophotographic photoreceptor 413. The electrophotographic photoreceptor 413 is a negatively-charged organic photoreceptor having photoconductivity. The electrophotographic photoreceptor 413 is charged by a charging device 414.

The developing device 412 is a two-component development type developing device. The developing device 412 includes, for example, a developing container that accommodates a two-component developer, a developing roller (magnetic roller) rotatably disposed at the opening of the developing container, a partition that partitions the inside of the developing container so as to allow the two-component developer to be communicable, a transport roller that transports the two-component developer on the opening side of the developing container toward the developing roller, and a stirring roller that stirs the two-component developer in the developing container The developing container accommodates, for example, a two-component developer.

The intermediate transfer unit 42 has an intermediate transfer belt (intermediate transfer member) 421, a primary transfer roller 422 that presses the intermediate transfer belt 421 onto the electrophotographic photoreceptor 413, a plurality of support rollers 423 including a backup roller 423A, and a belt cleaning device 426. The intermediate transfer belt 421 is stretched in a loop shape by the plurality of support rollers 423. When at least one driving roller of the plurality of support rollers 423 is rotated, the intermediate transfer belt 421 runs at a constant speed in the direction of the arrow A.

The belt cleaning device 426 has an elastic member 426a. The elastic member 426a comes in contact with the intermediate transfer belt 421 after the secondary transfer is conducted to remove deposits on the surface of the intermediate transfer belt 421. The elastic member 426a, which is composed of an elastic body, includes a cleaning blade, a brush, and the like.

The secondary transfer unit 43 includes an endless secondary transfer belt 432 and a plurality of support rollers 431 including a secondary transfer roller 431A. The secondary transfer belt 432 is stretched in a loop shape by the secondary transfer roller 431A and the support roller 431.

The fixing device 60 has, for example, a fixing roller 62, an endless heat generation belt 10 that covers the outer peripheral surface of the fixing roller 62 for heating and fusing the toner that constitutes the toner image on the sheet S, and a pressure roller 63 that presses the sheet S onto the fixing roller 62 and the heat generation belt 10. The sheet S corresponds to a recording medium.

The image forming apparatus 100 further has the image reading section 110, the image processing section 30, and the sheet transport section 50. The image reading section 110 has a sheet feeder 111 and a scanner 112. The sheet transport section 50 has a sheet feed section 51, a sheet ejection section 52, and a transport path section 53. In three sheet feed tray units 51a to 51c constituting the sheet feed section 51, the sheets S identified based on the basis weight, size, and the like (standard sheet, special sheet) are accommodated according to the pre-set kind. The transport path section 53 includes a plurality of transport roller pairs, such as a resist roller pair 53a.

<<Image Forming Method>>

The image forming method of the present invention is characterized by including: by use of the two-component developer of the present invention, attaching the electrostatic image developing toner contained in the two-component developer onto a recording medium; and fixing the electrostatic image developing toner attached to the recording medium. Hereinafter, the image forming method of the present invention will be described using the image forming apparatus 100.

The scanner 112 optically scans and reads a document D on the contact glass. The reflected light from the document D is read by a CCD sensor 112a as input image data. The input image data is subjected to predetermined image processing in the image processing section 30 and sent to the exposure device 411.

The electrophotographic photoreceptor 413 rotates at a constant peripheral speed. The charging device 414 negatively charges the surface of the electrophotographic photoreceptor 413 uniformly. In the exposure device 411, the polygon mirror of the polygon motor rotates at a high speed, and the laser beam corresponding to the input image data of each color component spreads along the axial direction of the electrophotographic photoreceptor413 and is applied to the outer peripheral surface of the electrophotographic photoreceptor 413 along the axial direction. In this manner, an electrostatic image is formed on the surface of the electrophotographic photoreceptor 413.

In the developing device 412, as a result of stirring and transporting the two-component developer in the developing container, toner particles are charged, and the two-component developer is transported to the developing roller to form a magnetic brush on the surface of the developing roller. The charged toner particles electrostatically adhere from the magnetic brush to the electrostatic image portion on the electrophotographic photoreceptor 413. In this manner, the electrostatic image on the surface of the electrophotographic photoreceptor 413 is visualized, and a toner image is formed correspondingly to the electrostatic image on the surface of the electrophotographic photoreceptor 413. The “toner image” refers to a state where toner particles are assembled in an image form.

The toner image on the surface of the electrophotographic photoreceptor 413 is transferred onto the intermediate transfer belt 421 by the intermediate transfer unit 42. The transfer residual toner remaining on the surface of the electrophotographic photoreceptor 413 after the transfer is removed by the drum cleaning device 415 having a drum cleaning blade that slidably contacts the surface of the electrophotographic photoreceptor 413.

When the primary transfer roller 422 presses the intermediate transfer belt 421 onto the electrophotographic photoreceptor 413, a primary transfer nip is formed for every electrophotographic photoreceptor by the electrophotographic photoreceptor 413 and the intermediate transfer belt 421. In the primary transfer nip, toner images of respective colors are successively transferred in a superimposed manner onto the intermediate transfer belt 421.

Meanwhile, the secondary transfer roller 431A is pressed onto the backup roller 42 A through the intermediate transfer belt 421 and the secondary transfer belt 432. As a result, a secondary transfer nip is formed by the intermediate transfer belt 421 and the secondary transfer belt 432. The sheet S passes through the secondary transfer nip. The sheet S is transported to the secondary transfer nip by the sheet transport section 50. The correction of the inclination of the sheet S and the adjustment of the timing of transport are performed by a resist roller section including the resist roller pair 53a disposed therein.

When the sheet S is transported to the secondary transfer nip, a transfer bias is applied to the secondary transfer roller 431A. As a result of the application of the transfer bias, the toner image supported on the intermediate transfer belt 42 is transferred onto the sheet S (step of attaching the electrostatic image developing toner onto a recording medium). The sheet S having the toner image transferred thereon is transported toward the fixing device 60 by the secondary transfer belt 432.

Deposits such as the transfer residual toner remaining on the surface of the intermediate transfer belt 421 after the secondary transfer are removed by the belt cleaning device 426 having a belt cleaning blade that slidably contacts the surface of the intermediate transfer belt 421. In this case, the intermediate transfer member mentioned above is used as the intermediate transfer belt, and thus a dynamic frictional force can be reduced over time.

The fixing device 60 forms a fixing nip by the heat generation belt 10 and the pressure roller 63, and the transported sheet S is heated and pressurized in the fixing nip section. In this manner, the toner image is fixed to the sheet S (step of fixing the electrostatic image developing toner on the recording medium). The sheet S including the toner image fixed thereon is ejected outside the apparatus from the sheet ejection section 52 equipped with a sheet ejection roller 52a.

### EXAMPLES

Hereinafter, the present invention will be concretely described by way of Examples, but the present invention is not limited thereto. A notation “part(s)” or ‘%’ used in Examples refers to “part(s) by mass” or “% by mass”, respectively, unless otherwise stated.

### Example 1

<<Production of Developer>>

[Production of Toner]

(Production of Toner Base Particles)

<Preparation of Pigment Particle Dispersion Liquid (1)>

Pigment Brown 25 (PBr25): 40 parts by mass

Pigment Blue 15:3 (PB15:3): 25 parts by mass

Pigment Violet 23 (PV23): 10 parts by mass

Pigment Yellow 155 (PY155): 25 parts by mass

Anionic surfactant: 15 parts by mass

Ion exchange water: 400 parts by mass

After the components described above were mixed and pre-dispersed with a homogenizer (ULTRA-TURRAX, manufactured by IKA Werke) for 10 minutes, the resultant was subjected to a dispersing treatment with a high-pressure impact-type disperser (Ultimizer manufactured by Sugino Machine Limited) at a pressure of 245 MPa for 30 minutes, and thereby an aqueous dispersion liquid containing these pigments was obtained. The ion exchange water was added to the resulting dispersion liquid to adjust the solid content to 15% by mass, thereby preparing a pigment particle dispersion liquid (1). The average particle diameter on a volume basis of the pigment particles in the pigment particle dispersion liquid (1) was 150 nm.

The above anionic surfactant used was NEOGEN RK manufactured by DKS Co. Ltd. (“NEOGEN” is a registered trademark of the company.).

<Preparation of Pigment Particle Dispersion Liquid (2)>

A pigment particle dispersion liquid (2) was prepared in the same manner as in Preparation of Pigment Particle Dispersion Liquid (1) except that Pigment Brown 23 (PBr23) was used instead of Pigment Brown 25. The average particle diameter on a volume basis of the pigment particles in the pigment particle dispersion liquid (2) was 150 nm.

<Preparation of Pigment Particle Dispersion Liquid (3)>

A pigment particle dispersion liquid (3) was prepared in the same manner as in Preparation of Pigment Particle Dispersion Liquid (1) except that Pigment Yellow 180 (PY180) was used instead of Pigment Yellow 155. The average particle diameter on a volume basis of the pigment particles in the pigment particle dispersion liquid (3) was 150 nm.

<Preparation of Pigment Particle Dispersion Liquid (4)>

A pigment particle dispersion liquid (4) was prepared in the same manner as in Preparation of Pigment Particle Dispersion Liquid (1) except that the formulation ratio of each organic pigment was changed as follows. The average particle diameter on a volume basis of the pigment particles in the pigment particle dispersion liquid (4) was 150 nm.

Pigment Brown 25 (PBr25): 60 parts by mass

Pigment Blue 15:3 (PB15:3): 40 parts by mass

Pigment Violet 23 (PV23): 0 part by mass

Pigment Yellow 155 (PY155): 0 part by mass

<Preparation of Pigment Particle Dispersion Liquid (5)>

A pigment particle dispersion liquid (5) was prepared in the same manner as in Preparation of Pigment Particle Dispersion Liquid (1) except that the formulation ratio of each organic pigment was changed as follows. The average particle diameter on a volume basis of the pigment particles in the pigment particle dispersion liquid (5) was 150 nm.

Pigment Brown 25 (PBr25): 0 part by mass

Pigment Blue 15:3 (PB15:3): 85 parts by mass

Pigment Violet 23 (PV23): 0 part by mass

Pigment Yellow 155 (PY155): 15 parts by mass

<Preparation of Pigment Particle Dispersion Liquid (6)>

A pigment particle dispersion liquid (6) was prepared in the same manner as in Preparation of Pigment Particle Dispersion Liquid (1) except that the formulation ratio of each organic pigment was changed as follows. The average particle diameter on a volume basis of the pigment particles in the pigment particle dispersion liquid (6) was 150 nm.

Pigment Brown 25 (PBr25): 0 part by mass

Pigment Blue 15:3 (PB15:3): 30 parts by mass

Pigment Violet 23 (PV23): 70 part by mass

Pigment Yellow 155 (PY155): 0 part by mass

<Preparation of Pigment Particle Dispersion Liquid (7)>

A pigment particle dispersion liquid (7) was prepared in the same manner as in Preparation of Pigment Particle Dispersion Liquid (1) except that 100 parts by mass of carbon black (CB) (REGAL 330 manufactured by Cabot Corporation (“REGAL” is a registered trademark of the company.)) were added instead of each of the organic pigments. The average particle diameter on a volume basis of the pigment particles in the pigment particle dispersion liquid (7) was 150 mm

<Preparation of Pigment Particle Dispersion Liquid (8)>

A pigment particle dispersion liquid (8) was prepared in the same manner as in Preparation of Pigment Particle Dispersion Liquid (1) except that the formulation ratio of each organic pigment was changed as follows. The average particle diameter on a volume basis of the pigment particles in the pigment particle dispersion liquid (8) was 150 nm.

Pigment Brown 25 (PBr25): 55 part by mass

Pigment Blue 15:3 (PB15:3): 0 part by mass

Pigment Violet 23 (PV23): 20 part by mass

Pigment Yellow 155 (PY155): 25 parts by mass

<Preparation of Pigment Particle Dispersion Liquid (9)>

A pigment particle dispersion liquid (9) was prepared in the same manner as in Preparation of Pigment Particle Dispersion Liquid (1) except that the formulation ratio of each organic pigment was changed as follows. The average particle diameter on a volume basis of the pigment particles in the pigment particle dispersion liquid (9) was 150 nm. The carbon black (CB) used was REGAL 330 manufactured by Cabot Corporation (“REGAL” is a registered trademark of the company.).

Pigment Brown 25 (PBr25): 40 parts by mass

Pigment Blue 15:3 (PB15:3): 21 parts by mass

Pigment Violet 23 (PV23): 10 parts by mass

Pigment Yellow 155 (PY155): 20 parts by mass

Carbon black (CB): 9 parts by mass

<Preparation of Pigment Particle Dispersion Liquid (10)>

A pigment particle dispersion liquid (10) was prepared in the same manner as in Preparation of Pigment Particle Dispersion Liquid (2) except that Pigment Orange 43 (P043) was used instead of Pigment Yellow 155. The average particle diameter on a volume basis of the pigment particles in the pigment particle dispersion liquid (10) was 150 nm.

<Preparation of Pigment Particle Dispersion Liquid (11)>

A pigment particle dispersion liquid (11) was prepared in the same manner as in Preparation of Pigment Particle Dispersion Liquid (2) except that Pigment Blue 15:4 (PB15:4) was used instead of Pigment Blue 15:3. The average particle diameter on a volume basis of the pigment particles in the pigment particle dispersion liquid (11) was 150 nm.

<Preparation of Pigment Particle Dispersion Liquid (12)>

A pigment particle dispersion liquid (12) was prepared in the same manner as in Preparation of Pigment Particle Dispersion Liquid (1) except that Pigment Brown 41 (PBr41) was used instead of Pigment Brown 25. The average particle diameter on a volume basis of the pigment particles in the pigment particle dispersion liquid (12) was 150 nm.

<Preparation of Pigment Particle Dispersion Liquid (13)>

A pigment particle dispersion liquid (13) was prepared in the same manner as in Preparation of Pigment Particle Dispersion Liquid (2) except that Pigment Violet 19 (PV19) was used instead of Pigment Violet 23. The average particle diameter on a volume basis of the pigment particles in the pigment particle dispersion liquid (13) was 150 nm.

<Preparation of Pigment Particle Dispersion Liquid (14)>

A pigment particle dispersion liquid (14) was prepared in the same manner as in Preparation of Pigment Particle Dispersion Liquid (2) except that Pigment Red 122 (PR122) was used instead of Pigment Violet 23. The average particle diameter on a volume basis of the pigment particles in the pigment particle dispersion liquid (14) was 150 nm.

<Preparation of Pigment Particle Dispersion Liquid (15)>

A pigment particle dispersion liquid (15) was prepared in the same manner as in Preparation of Pigment Particle Dispersion Liquid (2) except that Pigment Red 254 (PR254) was used instead of Pigment Violet 23. The average particle diameter on a volume basis of the pigment particles in the pigment particle dispersion liquid (15) was 150 nm.

<Preparation of Pigment Particle Dispersion Liquid (16)>

A pigment particle dispersion liquid (16) was prepared in the same manner as in Preparation of Pigment Particle Dispersion Liquid (2) except that Pigment Yellow 74 (PY74) was used instead of Pigment Yellow 155. The average particle diameter on a volume basis of the pigment particles in the pigment particle dispersion liquid (16) was 150 nm.

<Preparation of Pigment Particle Dispersion Liquid (17)>

A pigment particle dispersion liquid (17) was prepared in the same manner as in Preparation of Pigment Particle Dispersion Liquid (2) except that Pigment Yellow 185 (PY185) was used instead of Pigment Yellow 155. The average particle diameter on a volume basis of the pigment particles in the pigment particle dispersion liquid (17) was 150 nm.

<Preparation of Pigment Particle Dispersion Liquid (18)>

A pigment particle dispersion liquid (18) was prepared in the same manner as in Preparation of Pigment Particle Dispersion Liquid (2) except that the formulation ratio of each organic pigment was changed as follows. The average particle diameter on a volume basis of the pigment particles in the pigment particle dispersion liquid (18) was 150 nm. Two pigments were used as the pigment corresponding to P1-3, and the total amount thereof was 10 parts by mass

Pigment Brown 23 (PBr23): 40 parts by mass

Pigment Blue 15:3 (PB15:3): 25 parts by mass

Pigment Red 122 (PR122): 5 parts by mass

Pigment Violet 19 (PV19): 5 parts by mass

Pigment Yellow 155 (PY155): 25 parts by mass

The absorption maximum wavelength 2max (nm) of each of the pigments used in preparation of the pigment particle dispersion liquid, in dispersion in methyl ethyl ketone, are as shown below.

<P1-1>

Pigment Yellow 74 (PY74): 402 nm

Pigment Yellow 155 (PY155): 405 nm

Pigment Yellow 180 (PY180): 420 nm

Pigment Yellow 185 (PY185): 402 nm

<P1-2>

Pigment Brown 23 (PBr23): 490 nm

Pigment Brown 25 (PBr25): 490 nm

Pigment Brown 41 (PBr41): 490 nm

<P1-3>

Pigment Violet 19 (PV19): 570 nm

Pigment Violet 23 (PV23): 570 nm

Pigment Red 122 (PR122): 575 nm

Pigment Red 254 (PR254): 580 nm

Pigment Orange 43 (P043): 540 nm

<P2>

Pigment Blue 15:3 (PB15:3): 630 nm

Pigment Blue 15:4 (PB15:4): 630 nm

<Preparation of Amorphous Polyester Resin Particle Dispersion Liquid (a1)>

2.2 mol Ethylene oxide adduct of bisphenol A: 40 parts by mol

2.2 mol Propylene oxide adduct of bisphenol A: 60 parts by mol

Dimethyl terephthalate: 60 parts by mol

Dimethyl fumarate: 15 parts by mol

Dodecenyl succinic anhydride: 20 parts by mol

Trimellitic anhydride: 5 parts by mol

The monomers other than dimethyl fumarate and trimellitic anhydride, among the monomers described above, and 0.25 parts by mass of tin dioctylate based on 100 parts by mass of the total of the monomers were placed in a reaction vessel equipped with a stirrer, a thermometer, a condenser, and a nitrogen gas introduction tube. After a reaction was allowed to run at 235° C. for 6 hours under a nitrogen gas stream, the temperature was lowered to 200° C., and dimethyl fumarate and trimellitic anhydride in the amount described above were added to allow a reaction to run for 1 hour. The temperature was raised to 220° C. over 5 hours, and polymerization was conducted at a pressure of 10 kPa until a desired molecular weight was reached, and thereby a light yellow transparent amorphous polyester resin (A1) was obtained. The amorphous polyester resin (A) had a weight average molecular weight of 35,000, a number average molecular weight of 8,000, and a glass transition temperature (Tg) of 56° C.

Amorphous polyester resin (A1): 200 parts by mass

Methyl ethyl ketone: 100 parts by mass

Isopropyl alcohol: 35 parts by mass

Ammonia aqueous solution (10% by mass): 7 parts by mass

Then, the components described above were placed in a separable flask, and sufficiently mixed and dissolved. Thereafter ion exchange water was added dropwise using a liquid feed pump at a liquid feed rate of 8 g/min with heating and stirring at 40° C. The dropwise addition was terminated when the amount of the liquid fed reached 580 parts by mass Thereafter, the solvent was removed under reduced pressure, and an amorphous polyester resin particle dispersion liquid was obtained. Ion exchange water was added to the dispersion liquid to adjust the solid content to 25% by mass, thereby preparing an amorphous polyester resin particle dispersion liquid (al). The average particle diameter on a volume basis of the amorphous polyester resin (A1) in the amorphous polyester resin particle dispersion liquid (a1) was 156 nm.

<Preparation of Styrene-Acryl Resin Particle Dispersion Liquid (b1)>

5 parts by mass of an anionic surfactant (DOWFAX 2A1 manufactured by The Dow Chemical Company, “DOWFAX” is a trademark of the company) and 2500 parts by mass of ion exchange water were placed in a 5-L reaction vessel equipped with a stirrer, a temperature sensor, a condenser tube, and a nitrogen introduction device, and the interior temperature was raised to 75° C. with stirring at a stirring rate of 230 rpm under a nitrogen stream. Then, a solution containing 18 parts by mass of potassium persulfate (KPS) dissolved in 342 parts by mass of ion exchange water was added, and the liquid temperature was set to 75° C.

Styrene: 903 parts by mass

n-Butyl acrylate: 282parts by mass

Acrylate: 12 parts by mass

1,10-Decanedioldiacrylate: 3 parts by mass

Dodecanethiol: 8 parts by mass

Further, the mixed liquid of the monomers described above was added dropwise over 2 hours. After completion of the dropwise addition, polymerization was conducted by heating and stirring at 75° C. over 2 hours to thereby obtain an amorphous vinyl resin dispersion liquid. Ion exchange water was added to the dispersion liquid to adjust the solid content to 25% by mass to thereby prepare a dispersion liquid (b1) of a styrene-aciyl resin (B1) particles. The styrene-acryl resin (B1) had an average particle diameter on a volume basis of 160 nm, a weight average molecular weight (Mw) of 38,000, a number average molecular weight (Mn) of 15,000, and a glass transition temperature (Tg) of 52° C.

<Preparation of Crystalline Polyester Resin Particle Dispersion Liquid (c1)>

Dodecanedioic acid: 50 parts by mol

1,6-Hexanediol: 50 parts by mol

The monomers described above were placed in a reaction vessel equipped with a stirrer, a thermometer, a condenser, and a nitrogen gas introduction tube, and the inside of the reaction vessel was purged with a dry nitrogen gas. Then, 0.25 parts by mass of titanium tetrabutoxide (Ti(O-n-Bu)₄) were placed based on 100 parts by mass of the total of the monomers. After a reaction was conducted with stirring at 170° C. for 3 hours under a nitrogen gas stream, the temperature was further raised to 210° C. over 1 hour, the pressure in the reaction vessel was reduced to 3 kPa, a reaction was allowed to run under reduced pressure for 13 hours, and thereby a crystalline polyester resin (C1) was obtained. The crystalline polyester resin (C1) had a weight average molecular weight of 25,000, a number average molecular weight of 8,500, and a melting point of 71.8° C.

Crystalline polyester resin (C1): 200 parts by mass

Methyl ethyl ketone: 120 parts by mass

Isopropyl alcohol: 30 parts by mass

Next, the components described above were placed in a separable flask, and sufficiently mixed and dissolved at 60° C., and thereafter 8 parts by mass of a 10% by mass ammonia aqueous solution were added dropwise. The heating temperature was lowered to 67° C., ion exchange water was added dropwise using a liquid feed pump at a liquid feed rate of 8 g/min with stirring, and the dropwise addition of ion exchange water was terminated when the amount of the liquid fed reached 580 parts by mass. Thereafter, the solvent was removed under reduced pressure, and a crystalline polyester resin particle dispersion liquid was obtained. Ion exchange water was added to the dispersion liquid to adjust the solid content to 25% by mass, thereby preparing a crystalline polyester resin particle dispersion liquid (c1). The average particle diameter on a volume basis of the crystalline polyester resin (C1) in the crystalline polyester resin particle dispersion liquid (c 1) was 198 nm.

<Preparation of Mold-Releasing Agent Particle Dispersion Liquid (W1)>

Paraffin wax: 270 parts by mass

Anionic surfactant: 13.5 parts by mass (active ingredient: 60%, 3% relative to the paraffin was)

Ion exchange water: 21.6 parts by mass

After the components described above were mixed and the mold-releasing agent was dissolved at an internal liquid temperature of 120° C. in a pressure discharge type homogenizer (Gaulin Homogenizer manufactured by Gaulin Inc.), the resultant was subjected to a dispersing treatment at a dispersion pressure of 5 MPa for 120 minutes and subsequently at 40 MPa for 360 minutes, and cooled, and thereby a dispersion liquid was obtained. The ion exchange water was added to adjust the solid content to 20% to prepare a mold-releasing agent particle dispersion liquid (W1). The average particle diameter on a volume basis of the particles in the mold-releasing agent particle dispersion liquid (W1) was 215 nm.

The above paraffin wax used was HNP 0190 manufactured by Nippon Seiro Co., Ltd. (melting temperature: 85° C.), and the above anionic surfactant used was Neogen RK manufactured by DKS Co. Ltd.

<Production of Toner Base Particles (1)>

Amorphous polyester resin particle dispersion liquid (a1): 1280 parts by mass

Crystalline polyester resin particle dispersion liquid (c1): 160 parts by mass

Mold-releasing agent particle dispersion liquid (W1): 200 parts by mass

Pigment particle dispersion liquid (1): 335 parts by mass

Anionic surfactant: 40 parts by mass

Ion exchange water: 1500 parts by mass

The materials described above were placed in a 4-L reaction vessel equipped with a thermometer, a pH meter, and a stirrer, and a 1.0% nitric acid aqueous solution was added at a temperature of 25° C. to adjust the pH to 3.0. Thereafter, 100 parts by mass of a 2.0% by mass aluminum sulfate (coagulant) aqueous solution were added over 30 minutes while dispersion was conducted with a homogenizer (ULTRA-TURRAX T50 manufactured by IKA Werke) at 3000 rpm. After completion of the dropwise addition, stirring was made for 10 minutes to sufficiently mix the raw materials and the coagulant.

Amorphous polyester resin particle dispersion liquid (a1): 160 parts by mass

Anionic surfactant: 15 parts by mass

Thereafter, a stirrer and a mantle heater were mounted to the reaction vessel, and the temperature was raised at a temperature increase rate of 0.2° C./min up to 40° C. and at a temperature increase rate of 0.05° C./min after the temperature exceeded 40° C., with the number of rotations of the stirrer being adjusted so that a slurry was sufficiently stirred. The particle diameter was measured with a particle size distribution analyzer (Coulter Multisizer 3 manufactured by Beckman Coulter, Inc. (aperture size: 100 μm)) every 10 minutes. When an average particle diameter on a volume basis of 5.9 μm was reached, the temperature was kept, and the mixture of the above materials mixed in advance was placed over 20 minutes. As the above anionic surfactant placed twice, DOWFAX 2A1 (20% aqueous solution) manufactured by The Dow Chemical Company) was used in both the times.

Subsequently, the temperature was kept at 50° C. for 30 minutes, 8 parts by mass of a 20% by mass EDTA (ethylenediaminetetraacetic acid) aqueous solution were added to the reaction vessel. Thereafter, a 1 mol/L sodium hydroxide aqueous solution was added thereto to control the pH of the raw material dispersion liquid to 9.0. Thereafter, while the pH was adjusted to 9.0 every 5° C., the temperature was raised to 85° C. at a temperature increase rate of 1° C./min and kept at 85° C.

Thereafter, when the shape factor reached 0.970 as measured with a particle size meter (FPIA-3000 manufactured by Malvern Panalytical Ltd.), the resultant was cooled at a temperature decrease rate of 10° C./min, and thereby a toner base particle dispersion liquid (1) was obtained.

Then, solids obtained by filtering the toner base particle dispersion liquid (1) were sufficiently washed with ion exchange water. Subsequently, the resultant was dried at 40° C., and thereby toner base particles (1) were obtained. The average particle diameter on a volume basis of the toner base particles (1) obtained was 6.0 μm, and the average circularity thereof measured using a particle size meter (FPIA-3000 manufactured by Malvern Panalytical Ltd.) was 0.972.

<Production of Toner Base Particles (2)>

Styrene-acryl resin particle dispersion liquid (b1): 1280 parts by mass

Crystalline polyester resin particle dispersion liquid (c1): 160 parts by mass

Mold-releasing agent particle dispersion liquid (W1): 200 parts by mass

Pigment particle dispersion liquid (1): 335 parts by mass

Anionic surfactant: 40 parts by mass

Ion exchange water: 1500 parts by mass

The materials described above were placed in a 4-L reaction vessel equipped with a thermometer, a pH meter, and a stirrer, and a 1.0% nitric acid aqueous solution was added at a temperature of 25° C. to adjust the pH to 3.0. Thereafter, 100 parts by mass of a 2.0% by mass aluminum sulfate (coagulant) aqueous solution were added over 30 minutes while dispersion was conducted with a homogenizer (ULTRA-TURRAX T50 manufactured by IKA Werke) at 3000 rpm. After completion of the dropwise addition, stirring was made for 10 minutes to sufficiently mix the raw materials and the coagulant.

Amorphous polyester resin particle dispersion liquid (a1): 160 parts by mass

Anionic surfactant: 15 parts by mass

Thereafter, a stirrer and a mantle heater were mounted to the reaction vessel, and the temperature was raised at a temperature increase rate of 0.2° C./min up to 40° C. and at a temperature increase rate of 0.05° C./min after the temperature exceeded 40° C., with the number of rotations of the stirrer being adjusted so that a slurry was sufficiently stirred. The particle diameter was measured with a particle size distribution analyzer (Coulter Multisizer 3 manufactured by Beckman Coulter, Inc. (aperture size: 100 μm)) every 10 minutes. When an average particle diameter on a volume basis of 5.9 μm was reached, the temperature was kept, and the mixture of the above materials mixed in advance was placed over 20 minutes. As the above anionic surfactant placed twice, DOWFAX 2A1 (20% aqueous solution) manufactured by The Dow Chemical Company) was used in the both cases.

Subsequently, the temperature was kept at 50° C. for 30 minutes, 8 parts by mass of a 20% by mass EDTA (ethylenediaminetetraacetic acid) aqueous solution were added to the reaction vessel. Thereafter, a 1 mol/L sodium hydroxide aqueous solution was added thereto to control the pH of the raw material dispersion liquid to 9.0. Thereafter, while the pH was adjusted to 9.0 every 5° C., the temperature was raised to 85° C. at a temperature increase rate of 1° C./min and kept at 85° C.

Thereafter, when the shape factor reached 0.970 as measured with a particle size meter (FPIA-3000 manufactured by Malvern Panalytical Ltd.), the resultant was cooled at a temperature decrease rate of 10° C./min, and thereby a toner base particle dispersion liquid (2) was obtained.

Then, solids obtained by filtering the toner base particle dispersion liquid (2) were sufficiently washed with ion exchange water. Subsequently, the resultant was dried at 40° C., and thereby toner base particles (2) were obtained. The average particle diameter on a volume basis of the toner base particles (2) obtained was 6.0 μm, and the average circularity thereof measured using a particle size meter (FPIA-3000 manufactured by Malvern Panalytical Ltd.) was 0.972.

<Production of Toner Base Particles (3)>

Styrene-acryl resin particle dispersion liquid (b 1): 1600 parts by mass

Mold-releasing agent particle dispersion liquid (W1): 200 parts by mass

Pigment particle dispersion liquid (1): 335 parts by mass

Anionic surfactant: 40 parts by mass

Ion exchange water: 1500 parts by mass

The materials described above were placed in a 4-L reaction vessel equipped with a thermometer, a pH meter, and a stirrer, and a 1.0% nitric acid aqueous solution was added at a temperature of 25° C. to adjust the pH to 3.0. Thereafter, 100 parts by mass of a 2.0% by mass aluminum sulfate (coagulant) aqueous solution were added over 30 minutes while dispersion was conducted with a homogenizer (ULTRA-TURRAX T50 manufactured by IKA Werke) at 3000 rpm. After completion of the dropwise addition, stirring was made for 10 minutes to sufficiently mix the raw materials and the coagulant.

Thereafter, a stirrer and a mantle heater were mounted to the reaction vessel, and the temperature was raised at a temperature increase rate of 0.2° C./min up to 40° C. and at a temperature increase rate of 0.05° C./min after the temperature exceeded 40° C., with the number of rotations of the stirrer being adjusted so that a slurry was sufficiently stirred. The particle diameter was measured with a particle size distribution analyzer (Coulter

Multisizer 3 manufactured by Beckman Coulter, Inc. (aperture size: 100 μm)) every 10 minutes. When an average particle diameter on a volume basis of 6.0 μm was reached, the temperature was kept. Subsequently, the temperature was kept at 50° C. for 30 minutes, 8 parts by mass of a 20% by mass EDTA (ethylenediaminetetraacetic acid) aqueous solution were added to the reaction vessel. Thereafter, a 1 mol/L sodium hydroxide aqueous solution was added thereto to control the pH of the raw material dispersion liquid to 9.0. Thereafter, while the pH was adjusted to 9.0 every 5° C., the temperature was raised to 90° C. at a temperature increase rate of 1° C./min and kept at 90° C. When the shape factor reached 0.970 as measured with a particle size meter (FPIA-3000 manufactured by Malvern Panalytical Ltd.), the resultant was cooled at a temperature decrease rate of 10° C./min, and thereby a toner base particle dispersion liquid (3) was obtained.

Then, solids obtained by filtering the toner base particle dispersion liquid (3) were sufficiently washed with ion exchange water. Subsequently, the resultant was dried at 40° C., and thereby toner base particles (3) were obtained. The average particle diameter on a volume basis of the toner base particles (3) obtained was 6.0 μ, and the average circularity thereof measured using a particle size meter (FPIA-3000 manufactured by Malvern Panalytical Ltd.) was 0.972.

<Production of Toner Base Particles (4)>

Toner base particles (4) were obtained in the same manner as in Production of Toner Base Particles (1) except that the pigment particle dispersion liquid (2) was used instead of the pigment particle dispersion liquid (1).

<Production of Toner Base Particles (5)>

Toner base particles (5) were obtained in the same manner as in Production of Toner Base Particles (1) except that the pigment particle dispersion liquid (3) was used instead of the pigment particle dispersion liquid (1).

<Production of Toner Base Particles (6)>

Toner base particles (6) were obtained in the same manner as in Production of Toner Base Particles (1) except that the pigment particle dispersion liquid (4) was used instead of the pigment particle dispersion liquid (1).

<Production of Toner Base Particles (7)>

Toner base particles (7) were obtained in the same manner as in Production of Toner Base Particles (1) except that the pigment particle dispersion liquid (5) was used instead of the pigment particle dispersion liquid (1).

<Production of Toner Base Particles (8)>

Toner base particles (8) were obtained in the same manner as in Production of Toner Base Particles (1) except that the pigment particle dispersion liquid (6) was used instead of the pigment particle dispersion liquid (1).

<Production of Toner Base Particles (9)>

Toner base particles (9) were obtained in the same manner as in Production of Toner Base Particles (1) except that the pigment particle dispersion liquid (7) was used instead of the pigment particle dispersion liquid (1).

<Production of Toner Base Particles (10)>

Toner base particles (10) were obtained in the same manner as in Production of Toner Base Particles (1) except that the pigment particle dispersion liquid (8) was used instead of the pigment particle dispersion liquid (1).

<Production of Toner Base Particles (11)>

Toner base particles (11) were obtained in the same manner as in Production of Toner Base Particles (1) except that the pigment particle dispersion liquid (9) was used instead of the pigment particle dispersion liquid (1).

<Production of Toner Base Particles (12)>

Toner base particles (12) were obtained in the same manner as in Production of Toner Base Particles (2) except that the pigment particle dispersion liquid (10) was used instead of the pigment particle dispersion liquid (1).

<Production of Toner Base Particles (13)>

Toner base particles (13) were obtained in the same manner as in Production of Toner Base Particles (2) except that the pigment particle dispersion liquid (11) was used instead of the pigment particle dispersion liquid (1).

<Production of Toner Base Particles (14)>

Toner base particles (14) were obtained in the same manner as in Production of Toner Base Particles (2) except that the pigment particle dispersion liquid (12) was used instead of the pigment particle dispersion liquid (1).

<Production of Toner Base Particles (15)>

Toner base particles (15) were obtained in the same manner as in Production of Toner Base Particles (2) except that the pigment particle dispersion liquid (13) was used instead of the pigment particle dispersion liquid (1).

<Production of Toner Base Particles (16)>

Toner base particles (16) were obtained in the same manner as in Production of Toner Base Particles (2) except that the pigment particle dispersion liquid (14) was used instead of the pigment particle dispersion liquid (1).

<Production of Toner Base Particles (17)>

Toner base particles (17) were obtained in the same manner as in Production of Toner Base Particles (2) except that the pigment particle dispersion liquid (15) was used instead of the pigment particle dispersion liquid (1).

<Production of Toner Base Particles (18)>

Toner base particles (18) were obtained in the same manner as in Production of Toner Base Particles (2) except that the pigment particle dispersion liquid (16) was used instead of the pigment particle dispersion liquid (1).

<Production of Toner Base Particles (19)>

Toner base particles (19) were obtained in the same manner as in Production of Toner Base Particles (2) except that the pigment particle dispersion liquid (17) was used instead of the pigment particle dispersion liquid (1).

<Production of Toner Base Particles (20)>

Toner base particles (20) were obtained in the same manner as in Production of Toner Base Particles (2) except that the pigment particle dispersion liquid (18) was used instead of the pigment particle dispersion liquid (1).

[Production of External Additive]

<Production of Titanium Oxide Particulates>

Anatase-type titanium oxide having a number average primary particle diameter of 30 nm was subjected to a surface modification treatment with isobutyltrimethoxysilane, which is a hydrophobizing agent, by an aqueous wet process to thereby obtain hydrophobic titanium oxide. The hydrophobic titanium oxide obtained was used as titanium oxide particulates.

[Production of Toner]

<Production of Toner (1)>

Toner base particles (1): 100 parts by mass

Titanium oxide: 0.5 parts by mass

Silica (number average particle diameter: 20 nm): 3.5 parts by mass

The materials described above were mixed in a Henschel mixer for 20 minutes to obtain a toner (1).

For the number average particle diameter of the silica particles, a SEM micrograph magnified 50000 times using a scanning electron microscope (SEM) (JEM-7401F manufactured by JEOL Ltd.) was captured with a scanner, and the silica particles in the SEM micrograph image were binarized with an image processing analyzer (LUZEX AP manufactured by NIRECO CORPORATION). The horizontal Feret diameters of 100 silica particles were calculated, and the average value was taken as the number average particle diameter.

<Production of toners (2) to (24)>

Toners (2) to (24) were obtained by making changes appropriately such that the type of toner base particles and the content of titanium oxide would be as shown in Table I and Table II. No titanium oxide was added in the toner (23).

The contents of pigments, carbon black, and titanium oxide in Table I and Table II below represent the contents based on the total mass of the toner base particles.

TABLE I

| | Toner base particles | | | | | | | | | | | | | External |
|---|---|---|---|---|---|---|---|---|---|---|---|---|---|---|
| | | Colorant | | | | | | | | | | | | additive |
| | | | | | | | | | | | Carbon | | | Titanium |
| | Toner | Pigment | Pigment P1-2 | | Pigment P2 | | Pigment P1-3 | | Pigment P1-1 | | black | | | oxide |
| | base | dispersion | | Content | | Content | | Content | | Content | content | Binding resin | | content |
| Toner | particles | liquid | | [% by | | [% by | | [% by | | [% by | [% by | Crystalline | | [% by |
| No. | No. | No. | Type | mass] | Type | mass] | Type | mass] | Type | mass] | mass] | polyester | Others | mass] |
| 1 | 1 | 1 | PBr25 | 4.0 | PB15:3 | 2.5 | PV23 | 1.0 | PY155 | 2.5 | — | C1 | A1 | 0.5 |
| 2 | 2 | 1 | PBr25 | 4.0 | PB15:3 | 2.5 | PV23 | 1.0 | PY155 | 2.5 | — | C1 | A1/B1 | 0.5 |
| 3 | 3 | 1 | PBr25 | 4.0 | PB15:3 | 2.5 | PV23 | 1.0 | PY155 | 2.5 | — | — | B1 | 0.5 |
| 4 | 4 | 2 | PBr23 | 4.0 | PB15:3 | 2.5 | PV23 | 1.0 | PY155 | 2.5 | — | C1 | A1 | 0.5 |
| 5 | 5 | 3 | PBr25 | 4.0 | PB15:3 | 2.5 | PV23 | 1.0 | PY180 | 2.5 | — | C1 | A1 | 0.5 |
| 6 | 6 | 4 | PBr25 | 6.0 | PB15:3 | 4.0 | — | — | — | — | — | C1 | A1 | 0.5 |
| 7 | 7 | 5 | — | — | PB15:3 | 8.5 | — | — | PY155 | 1.5 | — | C1 | A1 | 0.5 |
| 8 | 8 | 6 | — | — | PB15:3 | 3.0 | PV23 | 7.0 | — | — | — | C1 | A1 | 0.5 |
| 9 | 1 | 1 | PBr25 | 4.0 | PB15:3 | 2.5 | PV23 | 1.0 | PY155 | 2.5 | — | C1 | A1 | 0.01 |
| 10 | 1 | 1 | PBr25 | 4.0 | PB15:3 | 2.5 | PV23 | 1.0 | PY155 | 2.5 | — | C1 | A1 | 0.9 |
| 11 | 11 | 9 | PBr25 | 4.0 | PB15:3 | 2.1 | PV23 | 1.0 | PY155 | 2.0 | 0.9 | C1 | A1 | 0.5 |
| 12 | 12 | 10 | PBr23 | 4.0 | PB15:3 | 2.5 | PV23 | 1.0 | PO43 | 2.5 | — | C1 | A1/B1 | 0.5 |

TABLE II

| | Toner base particles | | | | | | | | | | | | | External |
|---|---|---|---|---|---|---|---|---|---|---|---|---|---|---|
| | | Colorant | | | | | | | | | | | | additive |
| | | | | | | | | | | | Carbon | | | Titanium |
| | Toner | Pigment | Pigment P1-2 | | Pigment P2 | | Pigment P1-3 | | Pigment P1-1 | | black | | | oxide |
| | base | dispersion | | Content | | Content | | Content | | Content | content | Binding resin | | content |
| Toner | particles | liquid | | [% by | | [% by | | [% by | | [% by | [% by | Crystalline | | [% by |
| No. | No. | No. | Type | mass] | Type | mass] | Type | mass] | Type | mass] | mass] | polyester | Others | mass] |
| 13 | 13 | 11 | PBr23 | 4.0 | PB15:4 | 2.5 | PV23 | 1.0 | PY155 | 2.5 | — | C1 | A1/B1 | 0.5 |
| 14 | 14 | 12 | PBr41 | 4.0 | PB15:3 | 2.5 | PV23 | 1.0 | PY155 | 2.5 | — | C1 | A1/B1 | 0.5 |
| 15 | 15 | 13 | PBr23 | 4.0 | PB15:3 | 2.5 | PV19 | 1.0 | PY155 | 2.5 | — | C1 | A1/B1 | 0.5 |
| 16 | 16 | 14 | PBr23 | 4.0 | PB15:3 | 2.5 | PR122 | 1.0 | PY155 | 2.5 | — | C1 | A1/B1 | 0.5 |
| 17 | 17 | 15 | PBr23 | 4.0 | PB15:3 | 2.5 | PR254 | 1.0 | PY155 | 2.5 | — | C1 | A1/B1 | 0.5 |
| 18 | 18 | 16 | PBr23 | 4.0 | PB15:3 | 2.5 | PV23 | 1.0 | PY74 | 2.5 | — | C1 | A1/B1 | 0.5 |
| 19 | 19 | 17 | PBr23 | 4.0 | PB15:3 | 2.5 | PV23 | 1.0 | PY185 | 2.5 | — | C1 | A1/B1 | 0.5 |
| 20 | 20 | 18 | PBr23 | 4.0 | PB15:3 | 2.5 | PR122 | 1.0 | PY155 | 2.5 | — | C1 | A1/B1 | 0.5 |
| | | | | | | | PV19 | | | | | | | |
| 21 | 9 | 7 | — | — | — | — | — | — | — | — | 10 | C1 | A1 | 0.5 |
| 22 | 10 | 8 | PBr25 | 5.5 | — | — | PV23 | 2.0 | PY155 | 2.5 | — | C1 | A1 | 0.5 |
| 23 | 1 | 1 | PBr25 | 4.0 | PB15:3 | 2.5 | PV23 | 1.0 | PY155 | 2.5 | — | C1 | A1 | — |
| 24 | 1 | 1 | PBr25 | 4.0 | PB15:3 | 2.5 | PV23 | 1.0 | PY155 | 2.5 | — | C1 | A1 | 1.1 |

[Production of Carrier]

[Production of Carrier Core Material]

<Production of Carrier Core Material (1)>

MnO: 35.0 mol %

MgO: 14.5 mol %

Fe₂O₃: 50.0 mol %

SrO: 0.5 mol %

The materials described above were mixed with water and then pulverized for 5 hours in a wet media mill, and a slurry was obtained.

The slurry obtained was dried with a spray drier to thereby obtain perfectly spherical particles. The particles, after subjected to particle size adjustment, were heated at 950° C. for 2 hours and calcined in a rotary kiln. The calcined particles were pulverized for 1 hour in a dry ball mill using stainless steel beads having a diameter of 0.3 cm, polyvinyl alcohol (PVA) as the binder was then added thereto at 0.8% by mass with respect to the solids, water and a polycarboxylic acid type dispersing agent were further added thereto, and the resultant was pulverized for 30 hours using zirconia beads having a diameter of 0.5 cm. The resulting powder was granulated and dried with a spray dryer, and held in an electric furnace at a temperature of 1300° C. for 15 hours to conduct firing.

The fired powder was crushed and further classified to adjust the particle size. Thereafter, a product having a low magnetic strength was separated by magnetic separation, thereby a carrier core material (1) was obtained. The carrier core material (1) had a volume average particle diameter of 30 μm and a shape factor (SF-1) of 125.

The volume average particle diameter of the carrier core material described above was a value obtained in measurement by a wet process using a laser diffraction-type particle size distribution analyzer (HEROS KA manufactured by Japan Laser Corporation). Specifically, first, an optical system at a focus position of 200 mm was selected, and the measurement time was set to 5 seconds. A carrier core material for measurement was then added to a 0.2% by mass sodium dodecyl sulfate aqueous solution, and dispersed using an ultrasonic washer (US-1 manufactured by As One Corporation) for 3 minutes to produce a specimen dispersion liquid for measurement, several droplets thereof were fed to the laser diffraction-type particle size distribution analyzer described above, and measurement was started at a time when the specimen concentration gauge reached a measurable range. The resulting particle size was used to create the cumulative distribution from the smaller size with respect to the particle size range (channel), and the volume average particle diameter was calculated based thereon.

The shape factor of the carrier core material described above was measured by the following method. Micrographs of 100 or more particles of the carrier core material were randomly photographed at magnification of 150 times with a scanning electron microscope, and micrograph images captured with a scanner were used to measure the maximum length and projected area of the core material particles using an image processing analyzer LUZEX AP (manufactured by NIRECO CORPORATION). The “maximum length” is referred to as the maximum value of the lengths across in the image of each of the particles. A value calculated from the average value of the shape factors SF-1 calculated by the expression described above in the 100 core material particles was taken as the shape factor.

SF-1 =(maximum length of carrier core material particle)²/(projected area of carrier core material particle)×(π/4)×100

<Production of Carrier Core Material (2)>

A carrier core material (2) was obtained in the same manner as in Production of Carrier Core Material (1) except that the firing temperature in the carrier core material (1) was changed to 1100° C. The carrier core material (2) had a volume average particle diameter of 30 μm and an SF-1 of 105.

<Production of Carrier Core Material (3)>

A carrier core material (3) was obtained in the same manner as in Production of Carrier Core Material (1) except that the firing temperature in the carrier core material (1) was changed to 1500° C. The carrier core material (3) had a volume average particle diameter of 30 μm and an SF-1 of 145.

[Production of Resin for Coating]

Cyclohexyl methacrylate (CHMA) and methyl methacrylate (MMA) at a mass ratio (copolymerization ratio) of 50:50 were added to a 0.3% by mass aqueous solution of sodium benzenesulfonate, and potassium persulfate was added thereto in an amount of 0.5% by mass relative to the total amount of the monomers. The mixture was subjected to the emulsion polymerization, and the resultant was spray-dried to thereby produce a resin for coating. The resin for coating had a weight average molecular weight of 500,000.

[Production of Carrier]

<Production of Carrier (1)>

In a high-speed stirring mixer equipped with a horizontal stirring blade, 100 parts by mass of the carrier core material (1) and 3.5 parts by mass of the resin for coating described above were placed, mixed and stirred at 22° C. for 15 minutes under a condition of a peripheral speed of the horizontal rotor of 8 m/sec, and then mixed at 120° C. for 50 minutes to coat the surface of the carrier core material with the resin for coating by the action of a mechanical impact force (mechanochemical method). Thereafter, the resultant was cooled to room temperature, and thereby a carrier (1) was obtained. The iron element content represented by the expression (2) described above was 12.

<Production of Carrier (2)>

A carrier (2) was obtained in the same manner as in Production of Carrier (1) except that the carrier core material (1) was replaced by the carrier core material (2). The iron element content represented by the expression (2) described above was 2.

<Production of Carrier (3)>

A carrier (3) was obtained in the same manner as in Production of Carrier (1) except that the carrier core material (1) was replaced by the carrier core material (3). The iron element content represented by the expression (2) described above was 20.

<Production of Carrier (4)>

A carrier (4) was obtained in the same manner as in Production of Carrier (1) except that the resin for coating was replaced by 3.5 parts by mass of methacrylate methyl (MMA). The iron element content represented by the expression (2) described above was 12.

<Production of Carrier (5)>

A carrier (5) was obtained in the same manner as in Production of Carrier (1) except that the carrier core material (1) was replaced by the carrier core material (2) and the amount of the resin for coating added was changed to 4.0 parts by mass. The iron element content represented by the expression (2) described above was 1.5.

<Production of Carrier (6)>

A carrier (6) was obtained in the same manner as in Production of Carrier (1) except that the carrier core material (1) was replaced by the carrier core material (3) and the amount of the resin for coating added was changed to 3.0 parts by mass. The iron element content represented by the expression (2) described above was 22.

The iron element content represented by the expression (2) described above was calculated by the following method. In surface element composition analysis by means of X-ray photoelectron spectroscopy (XPS measurement), a Cls spectrum for carbon, a Fe2p_{3/2} spectrum for iron, and an 0 is spectrum for oxygen were measured. Then, the contents of Fe, C, and 0 (number of atoms) in a unit area of the carrier surface, denote by “A_{C}”, “A_{O}” and “A_{Fe}”, respectively, were determined on the basis of the spectrum of each of these atoms, and the iron element content was calculated by the expression (2).

A K-Alpha manufactured by Thermo Fisher Scientific K.K. was used as the XPS measurement apparatus, and the measurement was conducted using an Al monochlomatic X-ray as the X-ray source with the acceleration voltage set at 7 kV and the emission current set at 6 mV.

For the XPS measurement, after a sample is introduced in the measuring chamber and the degree of vacuum of the measuring chamber reaches 9.0×10′ mbar, the X-ray is launched and the measurement is conducted.

Spot diameter: 400 μm

Number of Scans: 15

PASS Energy: 50 eV

Analysis method: Smart method

[Production of Developer]<Production of Developers (1) to (29)>

The toner and the carrier were mixed such that the toner concentration was 9% by mass, using a V-type mixer (manufactured by TOKUJU CORPORATION) at 25° C. for 30 minutes to thereby obtain developers (1) to (29).

<<Evaluation>>

Evaluation was conducted as follows. An evaluation apparatus used for outputting images was a bizhub PRESS C1100 (manufactured by KONICA MINOLTA, INC.) modified such that the surface temperature of the fixing heat roller was able to be varied in the range of 80 to 180° C. The evaluation apparatus, after its toner cartridges and developing devices were filled with toners and developers, respectively, was used as the image forming apparatus for evaluation.

(Near-infrared Light Transmission)

A solid image (2 cm×2 cm) having an amount of the toner attached of 4.5 g/m² was formed on an A4-size OK TOPCOAT+(127.9 g/m²) (manufactured by Oji Paper Co., Ltd.), and a reflection spectrum was measured using filter paper as a reference by means of a spectrophotometer HITACHI U-4100 to determine the reflectance within the range of wavelength from 800 to 1000 nm. A high reflectance means that the toner has almost no action of absorbing light in the near-infrared light region (wavelength: 800 to 1000 nm), that is, transmits near-infrared light with high efficiency. Using the reflectances obtained, the near-infrared light transmission of each toner was evaluated based on the following criteria.

AA: The reflectance is 90% or more.

BB: The reflectance is 85% or more and less than 90%.

CC: The reflectance is 80% or more and less than 85%.

DD: The reflectance is less than 80%.

(Image Density)

A solid image (2 cm×2 cm) having an amount of the toner attached of 4.5 g/m² was formed on an A4-size OK TOPCOAT+(127.9 g/m²) (manufactured by Oji Paper Co., Ltd.), and the reflection density of the solid portion of the image was measured using a reflection densitometer (RD-918 manufactured by Macbeth). Using the reflection densities (image densities), the image density of each toner was evaluated based on the following criteria.

AA: The image density is 1.50 or more.

BB: The image density is 1.40 or more and less than 1.50.

CC: The image density is 1.30 or more and less than 1.40.

DD: The image density is less than 1.30.

(resistance of chargeability to environmental conditions)

A strip-shaped solid image having a printing ratio of 5% was formed on an A4-size high-quality paper (65 g/m²) under both high-temperature and high-humidity (HH) (30° C., 85% RH) environmental conditions and low- temperature and low-humidity (LL) (10° C., 20% RH) environmental conditions. After 100000 copies were printed under each of the environments, the amount of charge of the toner was measured. The two-component developer in the developing device was sampled, and the amount of charge was measured using a blow-off charge amount measuring apparatus “TB-200” (manufactured by Toshiba Chemical Corporation). A smaller difference between the amounts of charge under the LL and the HH environment means that the resistance to environmental conditions of the chargeability is more excellent.

AA: The environmental difference A in the amount of charge of the toner is less than 8 μC/g.

BB: The environmental difference A in the amount of charge of the toner is 8 μC/g or more and less than 12 μC/g.

CC: The environmental difference A in the amount of charge of the toner is 12 μC/g or more and less than 15 μC/g.

DD: The environmental difference A in the amount of charge of the toner is 15 μC/g or more.

(Low-Temperature Fixability)

The low-temperature fixability of the toner was evaluated using an A4-size OK TOPCOAT+(127.9 g/m²) (manufactured by Oji Paper Co., Ltd.) under normal-temperature and normal-humidity (NN) (20° C., 50% RH) environmental conditions. A fixing experiment to fix a solid image having an amount of toner attached of 10 g/m² was repeatedly conducted while the temperature of the fixing lower roller was set lower by 20° C. than that of the fixing upper belt and the surface temperature of the fixing upper belt was raised from 80° C. in 5° C. increments up to 140° C.

AA: The fixing temperature is less than 120° C.

BB: The fixing temperature is 120° C. or more and less than 135° C.

CC: The fixing temperature is 135° C. or more and less than 150° C.

DD: The fixing temperature is 150° C. or more.

The evaluation results are shown in Table III; provided that “* Resin” indicates the content of the structural unit derived from an alicyclic (meth)acrylic ester based on the total mass of the resin for coating.

[Table 3]

TABLE III

| | | Carrier | | | | | | | | |
|---|---|---|---|---|---|---|---|---|---|---|
| | | | | Iron | | Evaluation | | | | |
| | | | Carrier | element | | | | | Near- | |
| | Toner | | core | Content | *Resin | | Low | | infrared | |
| Developer | Toner | Carrier | material | [atomic | [% by | Charging | temperature | Image | light | |
| No. | No. | No. | No. | %] | mass] | durability | fixability | density | transmission | Remark |
| 1 | 1 | 1 | 1 | 12 | 50 | AA | AA | AA | AA | Example |
| 2 | 2 | 1 | 1 | 12 | 50 | AA | BB | AA | AA | Example |
| 3 | 3 | 1 | 1 | 12 | 50 | AA | CC | AA | AA | Example |
| 4 | 4 | 1 | 1 | 12 | 50 | AA | AA | AA | AA | Example |
| 5 | 5 | 1 | 1 | 12 | 50 | AA | AA | AA | AA | Example |
| 6 | 6 | 1 | 1 | 12 | 50 | AA | AA | BB | BB | Example |
| 7 | 7 | 1 | 1 | 12 | 50 | AA | AA | CC | CC | Example |
| 8 | 8 | 1 | 1 | 12 | 50 | AA | AA | BB | CC | Example |
| 9 | 9 | 1 | 1 | 12 | 50 | BB | AA | AA | AA | Example |
| 10 | 10 | 1 | 1 | 12 | 50 | BB | AA | AA | AA | Example |
| 11 | 1 | 2 | 2 | 2 | 50 | CC | AA | AA | AA | Example |
| 12 | 1 | 3 | 3 | 20 | 50 | CC | AA | AA | AA | Example |
| 13 | 1 | 4 | 1 | 12 | — | BB | AA | AA | AA | Example |
| 14 | 11 | 1 | 1 | 12 | 50 | AA | AA | AA | AA | Example |
| 15 | 12 | 1 | 1 | 12 | 50 | AA | BB | AA | AA | Example |
| 16 | 13 | 1 | 1 | 12 | 50 | AA | BB | AA | AA | Example |
| 17 | 14 | 1 | 1 | 12 | 50 | AA | BB | AA | AA | Example |
| 18 | 15 | 1 | 1 | 12 | 50 | AA | BB | AA | AA | Example |
| 19 | 16 | 1 | 1 | 12 | 50 | AA | BB | AA | AA | Example |
| 20 | 17 | 1 | 1 | 12 | 50 | AA | BB | AA | AA | Example |
| 21 | 18 | 1 | 1 | 12 | 50 | AA | BB | AA | AA | Example |
| 22 | 19 | 1 | 1 | 12 | 50 | AA | BB | AA | AA | Example |
| 23 | 20 | 1 | 1 | 12 | 50 | AA | BB | AA | AA | Example |
| 24 | 21 | 1 | 1 | 12 | 50 | CC | CC | AA | DD | Comparative |
| | | | | | | | | | | Example |
| 25 | 22 | 1 | 1 | 12 | 50 | AA | AA | BB | DD | Comparative |
| | | | | | | | | | | Example |
| 26 | 23 | 1 | 1 | 12 | 50 | DD | AA | AA | AA | Comparative |
| | | | | | | | | | | Example |
| 27 | 24 | 1 | 1 | 12 | 50 | DD | AA | DD | AA | Comparative |
| | | | | | | | | | | Example |
| 28 | 1 | 5 | 2 | 1.5 | 50 | DD | AA | AA | AA | Comparative |
| | | | | | | | | | | Example |
| 29 | 1 | 6 | 3 | 22 | 50 | DD | AA | AA | AA | Comparative |
| | | | | | | | | | | Example |

From the results described above, it can be seen that the two-component developer of the present invention has near-infrared light transmission, has a high image density, and has excellent resistance of chargeability to environmental conditions. It can be also seen that appropriately selecting pigments improves near-infrared light transmission. Further, incorporation of crystalline polyester in the toner base particles allows the low-temperature fixability to be improved.

Although embodiments of the present invention have been described and illustrated in detail, the disclosed embodiments are made for purposes of illustration and example only and not limitation. The scope of the present invention should be interpreted by terms of the appended claims

What is claimed is:

1. A two-component developer comprising an electrostatic image developing toner and a carrier, the electrostatic image developing toner containing toner particles having toner base particles and an external additive, wherein
the toner base particles contain a colorant,
the colorant contains a pigment P1 and a pigment P2,
an absorption maximum wavelength λmax of the pigments P1 and P2 each in dispersion in methyl ethyl ketone is, in the range of 400 nm or more and less than 600 nm for the pigment P1 and
in the range of 600 nm or more and 700 nm or less for the pigment P2,
the external additive contains titanium oxide,
a content of the titanium oxide is 0.01% by mass or more and less than 1.00% by mass based on the total mass of the toner base particles, and
an iron element content (atomic %) of the surface of the carrier as measured by X-ray electron spectroscopy satisfies the following expression (1):
Expression (1): 2≤{A_{Fe}/(A_{C}+A_{O}+A_{Fe})}×100≤20
wherein A_{Fe}, A_{C}, and A_{O}represent respectively the contents of Fe, C, and O (atomic %) per unit area of the carrier surface.

2. The two-component developer according to claim 1, wherein
the pigment P1 contains a pigment P1-2, and
an absorption maximum wavelength λmax of the pigment P1-2 in dispersion in methyl ethyl ketone is within the range of 460 nm or more and 530 nm or less.

3. The two-component developer according to claim 2, wherein the pigment P1-2 comprises at least one pigment selected from the group consisting of C.I. Pigment Brown 23, C.I. Pigment Brown 25, C.I. Pigment Brown 41, and C.I. Pigment Red 38.

4. The two-component developer according to claim 1, wherein the pigment P2 comprises at least one pigment selected from the group consisting of C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 15:5, C.I. Pigment Blue 15:6, and C.I. Pigment Blue 16.

5. The two-component developer according to claim 1, wherein
the pigment P1 contains a pigment P1-3, and
an absorption maximum wavelength λmax (nm) of the pigment P1-3 in dispersion in methyl ethyl ketone is within the range of more than 530 nm and less than 600 nm.

6. The two-component developer according to claim 5, wherein the pigment P1-3 comprises at least one pigment selected from the group consisting of C.I. Pigment Orange 34, C.I. Pigment Orange 36, C.I. Pigment Orange 38, C.I. Pigment Orange 43, C.I. Pigment Orange 62, C.I. Pigment Orange 68, C.I. Pigment Orange 70, C.I. Pigment Orange 72, C.I. Pigment Orange 74, C.I. Pigment Red 31, C.I. Pigment Red 48:4, C.I. Pigment Red 57:1, C.I. Pigment Red 122, C.I. Pigment Red 146, C.I. Pigment Red 147, C.I. Pigment Red 150, C.I. Pigment Red 184, C.I. Pigment Red 238, C.I. Pigment Red 242, C.I. Pigment Red 254, C.I. Pigment Red 269, C.I. Pigment Violet 19, C.I. Pigment Violet 23, and C.I. Pigment Violet 32.

7. The two-component developer according to claim 1, wherein
the pigment P1 contains a pigment P1-1, and
an absorption maximum wavelength λmax (nm) of the pigment P1-1 in dispersion in methyl ethyl ketone is within the range of 400 nm or more and less than 460 nm.

8. The two-component developer according to claim 7, wherein the pigment P1-1 comprises at least one pigment selected from the group consisting of C.I. Pigment Yellow 74, C.I. Pigment Yellow 120, C.I. Pigment Yellow 139, C.I. Pigment Yellow 151, C.I. Pigment Yellow 155, C.I. Pigment Yellow 180, C.I. Pigment Yellow 181, C.I. Pigment Yellow 185, C.I. Pigment Yellow 213, C.I. Pigment Green 7, and C.I. Pigment Green 36.

9. The two-component developer according to claim 1, wherein the toner base particles contain crystalline polyester.

10. The two-component developer according to claim 1, wherein
the carrier has a resin layer on at least a surface of a core material, and
a resin contained in the resin layer contains a resin having a structural unit derived from an alicyclic (meth)acrylic ester.

11. The two-component developer according to claim 10, wherein a content of the structural unit derived from an alicyclic (meth)acrylic ester in the resin contained in the resin layer is 50% by mass or more based on the total mass of the resin contained in the resin layer.

12. An image forming method using a two-component developer, comprising:
by use of the two-component developer according to claim 1 as the two-component developer,
attaching the electrostatic image developing toner contained in the two-component developer onto a recording medium; and
fixing the attached electrostatic image developing toner on the recording medium.
